(19) United States
(12) Patent Application Publication
(10) Pub. No.: US 2024/0118392 A1
(43) Pub. Date: Apr. 11, 2024

(54) TWO-DIMENSIONAL SCANNERS FOR LIDAR SYSTEMS, AND RELATED METHODS AND APPARATUS

(71) Applicant: VELODYNE LIDAR USA, INC., San Jose, CA (US)

(72) Inventors: Mathew Noel Rekow, Santa Cruz, CA (US); Joseph B. Culkin, San Jose, CA (US)

(73) Assignee: VELODYNE LIDAR USA, INC., San Jose, CA (US)

(21) Appl. No.: 18/477,469

(22) Filed: Sep. 28, 2023

Related U.S. Application Data
(60) Provisional application No. 63/412,474, filed on Oct. 2, 2022.

(51) Int. Cl. G01S 7/481; G01S 17/89

(52) U.S. Cl. CPC G01S 7/4817; G01S 7/4813; G01S 17/89

(57) ABSTRACT

A two-dimensional (2D) lidar scanner includes a scan mirror assembly and rotary component. The scan mirror assembly includes a scan mirror and a mirror-tilting apparatus coupled to the scan mirror. The rotary component is coupled to the scan mirror assembly and can drive a rotary motion of the scan mirror assembly about a first axis. The mirror-tilting apparatus is configured to tilt the scan mirror about a second axis substantially perpendicular to the first axis in response to the rotary component driving the rotary motion of the scan mirror assembly. An orientation of the scan mirror is operable to control a first angle of reflection of a laser beam in a first dimension and a second angle of reflection of the laser beam in a second dimension during a lidar scanning process.

### CROSS REFERENCE TO RELATED APPLICATIONS

This application claims priority to U.S. Provisional Patent Application No. 63/412,474 filed on Oct. 2, 2022 and entitled “Two-Dimensional Scanners For Lidar Systems, And Related Methods and Apparatus”, which is incorporated by reference in its entirety.

### FIELD OF TECHNOLOGY

The present disclosure relates generally to lidar technology and, more specifically, to two-dimensional (“2D”) scanners for lidar systems.

### BACKGROUND

Lidar (light detection and ranging) systems measure the attributes of their surrounding environments (e.g., shape of a target, contour of a target, distance to a target, etc.) by illuminating the environment with light (e.g., laser light) and measuring the reflected light with sensors. Differences in laser return times and/or wavelengths can then be used to make digital, three-dimensional (“3D”) representations of a surrounding environment. Lidar technology may be used in various applications including autonomous vehicles, advanced driver assistance systems, mapping, security, surveying, robotics, geology and soil science, agriculture, unmanned aerial vehicles, airborne obstacle detection (e.g., obstacle detection systems for aircraft), etc. Depending on the application and associated field of view, multiple optical transmitters and/or optical receivers may be used to produce images in a desired resolution. A lidar system with greater numbers of transmitters and/or receivers can generally generate larger numbers of pixels.

In a multi-channel lidar device, optical transmitters can be paired with optical receivers to form multiple “channels.” In operation, each channel's transmitter can emit an optical signal (e.g., laser light) into the device's environment, and the channel's receiver can detect the portion of the signal that is reflected back to the channel's receiver by the surrounding environment. In this way, each channel can provide “point” measurements of the environment, which can be aggregated with the point measurements provided by the other channel(s) to form a “point cloud” of measurements of the environment.

The measurements collected by a lidar channel may be used to determine the distance (“range”) from the device to the surface in the environment that reflected the channel's transmitted optical signal back to the channel's receiver. In some cases, the range to a surface may be determined based on the time of flight of the channel's signal (e.g., the time elapsed from the transmitter's emission of the optical signal to the receiver's reception of the return signal reflected by the surface). In other cases, the range may be determined based on the wavelength (or frequency) of the return signal(s) reflected by the surface.

In some cases, lidar measurements may be used to determine the reflectance of the surface that reflects an optical signal. The reflectance of a surface may be determined based on the intensity of the return signal, which generally depends not only on the reflectance of the surface but also on the range to the surface, the emitted signal's glancing angle with respect to the surface, the power level of the channel's transmitter, the alignment of the channel's transmitter and receiver, and other factors.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

Disclosed herein are 2D scanners for lidar systems, and related methods and apparatus. In one aspect, a 2D lidar scanner includes a scan mirror assembly and a rotary component. The scan mirror assembly includes a scan mirror and a mirror-tilting apparatus coupled to the scan mirror. The rotary component is coupled to the scan mirror assembly and operable to drive the scan mirror assembly to rotate about a first axis. The mirror-tilting apparatus is configured to tilt the scan mirror about a second axis substantially perpendicular to the first axis in response to the rotary component driving the rotation of the scan mirror assembly. An orientation of the scan mirror is operable to control a first angle of reflection of a laser beam in a first dimension and a second angle of reflection of the laser beam in a second dimension during a lidar scanning process.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is an illustration of an exemplary lidar system, in accordance with some embodiments.

FIG. 2A is an illustration of the operation of a lidar system, in accordance with some embodiments.

FIG. 2B is an illustration of optical components of a channel of a lidar system with a movable mirror, in accordance with some embodiments.

FIG. 2C is an illustration of an example of a 3D lidar system, in accordance with some embodiments.

FIG. 2D is a block diagram of a transmitter-receiver optical sub-assembly (TROSA), according to some embodiments.

FIG. 3A is an illustration of an off-axis parabolic spinning mirror for a 2D scanner, according to some embodiments.

FIG. 3B is an illustration of a flat spinning mirror coupled to a collimating lens for a 2D scanner, according to some embodiments.

FIG. 4A is a block diagram of a 2D scanner, according to some embodiments.

FIG. 4B is an illustration of a 2D scanner, according to some embodiments.

FIG. 5A is an illustration of an exemplary 2D scanner, according to some

embodiments.

FIGS. 5B and 5C are illustrations of a technique for controlling a mirror to tilt, according to some embodiments.

FIGS. 6A-6D are illustrations of scan mirror tilt angle profiles in response to various angular velocities of a scanning mirror assembly in a 2D scanner, according to some embodiments.

FIG. 7 is an illustration of an exemplary scan pattern of a 2D scanner in a single-channel lidar device, according to some embodiments.

FIG. 8 is an illustration of an exemplary scan pattern of a 2D scanner in a multi-channel lidar device, according to some embodiments.

FIG. 9 is an illustration of exemplary laser beams emitted towards and reflected by a 2D scanner in different directions, according to some embodiments.

FIG. 10 is an illustration of an exemplary jerk-actuated tilt of a scan mirror included in a 2D scanner, according to some embodiments.

FIG. 11A is an illustration of an exemplary architecture of a mirror assembly included in a 2D scanner, according to some embodiments.

FIG. 11B is an illustration of a jerk response of the mirror assembly of FIG. 11A, according to some embodiments.

FIG. 12A is an illustration a scan mirror with a magnetic counterweight, according to some embodiments.

FIG. 12B is an illustration of an exemplary orientation sensor of a 2D scanner, according to some embodiments.

FIG. 12C is an illustration of an exemplary relationship between the tilt angle of the scan mirror and the voltage by the orientation sensor of FIG. 12A, according to some embodiments.

FIGS. 13A and 13B are illustrations of a mechanism for bringing the center of mass of a portion of a scan mirror assembly to the rotation plane, according to some embodiments.

FIG. 13C is an illustration of a balanced scan mirror assembly, according to some embodiments.

FIG. 14 is an illustration of an external view of an exemplary mirror assembly with counterweights, according to some embodiments.

FIG. 15A and 15B illustrate an exemplary arrangement of counterweights for a portion of a scan mirror assembly in a 2D scanner, according to some embodiments.

FIG. 15C and 15D illustrate an exemplary arrangement of counterweights for another portion of a scan mirror assembly in a 2D scanner, according to some embodiments.

FIGS. 16A and 16B illustrate a mechanism for applying a jerk-based net torque to a tiltable portion of a scan mirror assembly, according to some embodiments.

FIG. 17 is an illustration of a part of an exemplary resonance-free shaft-based 2D scanner, according to some embodiments.

FIG. 18 is an illustration of an exemplary lidar device including a resonance-free shaft-based 2D scanner, according to some embodiments.

FIG. 19 is an illustration of the locations of the centers of mass for the left and right halves of a scan mirror assembly before and after a mirror tilt, according to some embodiments.

FIG. 20 is an illustration of the locations of the centers of mass for the top and bottom halves of a scan mirror assembly, according to some embodiments.

FIG. 21 is a diagram of a vehicle including a plurality of sensors, in accordance with some embodiments.

FIG. 22 is a block diagram of a silicon photonic integrated circuit (PIC) in accordance with aspects described herein.

FIG. 23 is a block diagram of an example computer system, in accordance with some embodiments.

FIG. 24 is a block diagram of a computing device/information handling system, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

Two-dimensional scanners for lidar systems, and related methods and apparatus are disclosed. It will be appreciated that, for simplicity and clarity of illustration, where considered appropriate, reference numerals may be repeated among the figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details.

Three of the most significant technical challenges faced by the lidar industry are (1) reducing the manufacturing cost for lidar devices while maintaining existing performance levels, (2) improving the reliability of lidar devices under automotive operating conditions (e.g., weather, temperature, and mechanical vibration), and (3) increasing the range of lidar devices. One approach to reducing manufacturing costs is to reduce the amount of hardware (e.g., channels, transmitters, emitters, receivers, detectors, etc.) in the lidar device while increasing the utilization of the remaining hardware to maintain performance levels. One approach to improving device reliability is to develop lidar devices that use fewer moving mechanical parts (e.g., by eliminating or simplifying mechanical beam scanners). One approach to extending range is to develop lidar devices that use solid-state lasers.

### Motivation for and Benefits of Some Embodiments

There is a need for lidar systems that are smaller, lighter (lower weight), and/or more power-efficient. For example, the performance and capabilities of some unmanned aircraft (e.g., “drones”) can be enhanced by equipping such drones with lidar systems, but lidar systems that are bulky, heavy, and/or power-inefficient are generally not well-suited for use with drones. In addition, there is a need for lidar systems that can be manufactured at lower cost. For many lidar systems, the cost of manufacturing is strongly dependent on the number of lasers or channels in the lidar system. Thus, reducing the number of lasers or channels in a lidar system can significantly reduce the system's total manufacturing cost.

One approach to making lidar systems smaller, lighter, more efficient, and less expensive (while maintaining desired performance levels) is to reduce the number of lasers or channels in the system and increase their effective utilization. Some conventional lidar systems fire their individual laser emitters at rates of 10-40 KHz, even though the theoretical limit on a laser emitter's firing rate (in view of the speed of light) for a lidar system with 300-meter range is roughly 500 KHz (or 1 MHz for a lidar system with a 150-meter range.). For a multi-channel lidar system that operates in this manner, each channel fires very slowly, resulting in only about 3.6% utilization of its theoretical capacity.

Thus, one approach to increasing the laser or channel utilization is to increase the firing rates of the laser emitters and utilize the extra laser beams to scan the lidar system's environment more quickly. However, new scanner designs are needed to facilitate such an increase in laser firing rates. Such scanner designs are described herein.

Some embodiments of these scanner designs are also resilient to the perturbations generally experienced by lidar-equipped vehicles and/or robots, because such perturbations tend to be rectilinear rather than angular with respect to the axis of the scanner's rotation. Furthermore, when angular perturbations with respect to the axis of the scanner's rotation are experienced, the effects of such perturbations tend to have negligible impact on the scanner's performance because the frequencies of such perturbations are generally much lower than the frequencies of the scanner's rotation.

### Some Examples of Lidar Systems

A lidar system may be used to measure the shape and contour of the environment surrounding the system. Lidar systems may be applied to numerous applications including autonomous navigation and aerial mapping of surfaces. In general, a lidar system emits light that is subsequently reflected by objects within the environment in which the system operates. The light may be emitted by a laser (e.g., a rapidly firing laser). Laser light travels through a medium and reflects off points of surfaces in the environment (e.g., surfaces of buildings, tree branches, vehicles, etc.). The reflected (and/or scattered) light energy returns to a lidar detector where it may be sensed and used to perceive the environment.

The science of lidar systems is based on the physics of light and optics. Any suitable measurement techniques may be used to determine the attributes of objects in a lidar system's environment. In some examples, the lidar system is configured to emit light pulses (e.g., individual pulses or sequences of pulses). The time each pulse (or pulse sequence) travels from being emitted to being received (“time of flight” or “TOF”) may be measured to determine the distance between the lidar system and the object that reflects the pulse. Lidar systems that operate in this way may be referred to as “pulsed lidar,” “TOF lidar,” “direct TOF lidar,” or “pulsed TOF lidar.” In some other examples, the time of flight may be calculated indirectly (e.g., using amplitude-modulated continuous wave (AMCW) structured light). Lidar systems that operate in this way may be referred to as “indirect TOF lidar” or “iTOF lidar.” In still other examples, the lidar system can be configured to emit continuous wave (CW) light. The wavelength (or frequency) of the received, reflected light may be measured to determine the distance between the lidar system and the object that reflects the light. In some examples, lidar systems can measure the speed (or velocity) of objects. Lidar systems that operate in this way may be referred to as “coherent lidar,” “continuous wave lidar,” or “CW lidar.” In a CW lidar system, any suitable variant of CW lidar sensing may be used. For example, frequency modulated continuous wave (FMCW) lidar sensing may be used.

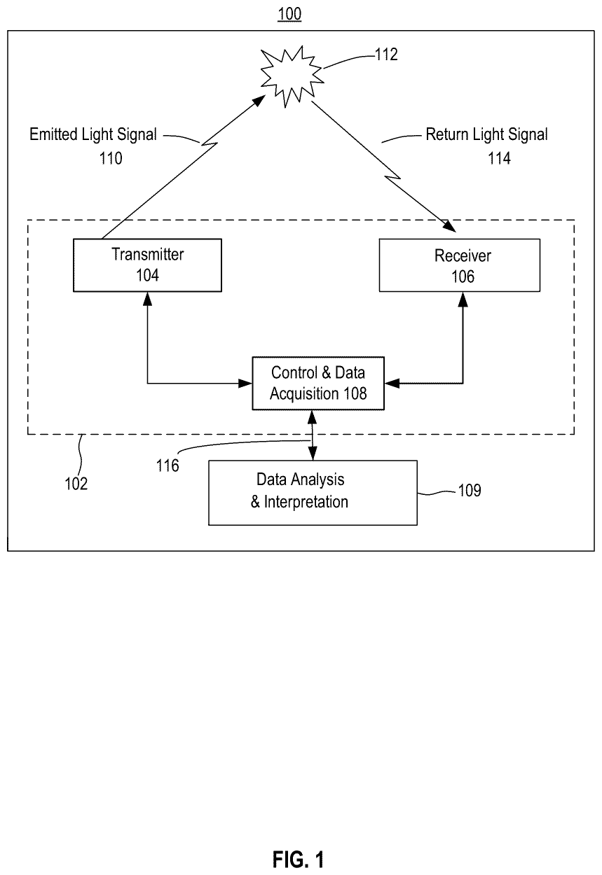

FIG. 1 depicts the operation of a lidar system 100, according to some embodiments. In the example of FIG. 1, the lidar system 100 includes a lidar device 102, which may include a transmitter 104 that generates and emits a light signal 110, a receiver 106 that detects and processes a return light signal 114, and a control & data acquisition module 108. The transmitter 104 may include a light source (e.g., “optical emitter” or “emitter”), electrical components operable to activate (e.g., drive) and deactivate the light source in response to electrical control signals, and optical components adapted to shape and redirect the light emitted by the light source. The receiver 106 may include a light detector (e.g., “optical detector,” “photodetector,” or “detector”) and optical components adapted to shape return light signals 114 and direct those signals to the detector. In some implementations, one or more optical components (e.g., lenses, mirrors, etc.) may be shared by the transmitter and the receiver.

The lidar device 102 may be referred to as a lidar transceiver or “channel.” In operation, the emitted light signal 110 propagates through a medium and reflects off an object(s) 112, whereby a return light signal 114 propagates through the medium and is received by receiver 106. In one example, each lidar channel may correspond to a physical mapping of a single emitter to a single detector (e.g., a one-to-one pairing of a particular emitter and a particular detector). In other examples, however, each lidar channel may correspond to a physical mapping of multiple emitters to a single detector or a physical mapping of a single emitter to multiple detectors (e.g., a “flash” configuration). In some examples, a lidar system 100 may have no fixed channels; rather, light emitted by one or more emitters may be detected by one or more detectors without any physical or persistent mapping of specific emitters to specific detectors.

Any suitable light source may be used including, without limitation, one or more gas lasers, chemical lasers, metal-vapor lasers, solid-state lasers (SSLs) (e.g., Q-switched SSLs, Q-switched solid-state bulk lasers, etc.), fiber lasers (e.g., Q-switched fiber lasers), liquid lasers (e.g., dye lasers), semiconductor lasers (e.g., laser diodes, edge emitting lasers (EELs), vertical-cavity surface emitting lasers (VCSELs), quantum cascade lasers, quantum dot lasers, quantum well lasers, hybrid silicon lasers, optically pumped semiconductor lasers, etc.), and/or any other device operable to emit light. For semiconductor lasers, any suitable gain medium may be used including, without limitation, gallium nitride (GaN), indium gallium nitride (InGaN), aluminum gallium indium phosphide (AlGaInP), aluminum gallium arsenide (AlGaAs), indium gallium arsenide phosphide (InGaAsP), lead salt, etc. For Q-switched lasers, any suitable type or variant of Q-switching can be used including, without limitation, active Q-switching, passive Q-switching, cavity dumping, regenerative Q-switching, etc. The light source may emit light having any suitable wavelength or wavelengths, including but not limited to wavelengths between 100 nm (or less) and 1 mm (or more). Semiconductor lasers operable to emit light having wavelengths of approximately 905 nm, 1300 nm, or 1550 nm are widely commercially available. In some examples, the light source may be operated as a pulsed laser, a continuous-wave (CW) laser, and/or a coherent laser. A light signal (e.g., “optical signal”) 110 emitted by a light source may consist of a single pulse, may include a sequence of two or more pulses, or may be a continuous wave.

A lidar system 100 may use any suitable illumination technique to illuminate the system's field of view (FOV). In some examples, the lidar system 100 may illuminate the entire FOV simultaneously. Such illumination techniques may be referred to herein as “flood illumination” or “flash illumination.” In some examples, the lidar system 100 may illuminate fixed, discrete spots throughout the FOV simultaneously. Such illumination techniques may be referred to herein as “fixed spot illumination.” In some examples, the lidar system 100 may illuminate a line within the FOV and use a scanner (e.g., a 1D scanner) to scan the line over the entire FOV. Such illumination techniques may be referred to herein as “scanned line illumination.” In some examples, the lidar system 100 may simultaneously illuminate one or more spots within the FOV and use a scanner (e.g., a 1D or 2D scanner) to scan the spots over the entire FOV. Such illumination techniques may be referred to herein as “scanned spot illumination.”

Any suitable optical detector may be used including, without limitation, one or more photodetectors, contact image sensors (CIS), solid-state photodetectors (e.g., photodiodes (PD), single-photon avalanche diode (SPADs), avalanche photodiodes (APDs), etc.), photomultipliers (e.g., silicon photomultipliers (SiPMs), and/or any other device operable to convert light (e.g., optical signals) into electrical signals. In some examples, CIS can be fabricated using a complementary metal-oxide semiconductor (CMOS) process. In some examples, solid-state photodetectors can be fabricated using semiconductor processes similar to CMOS. Such semiconductor processes may use silicon, germanium, indium gallium arsenide, lead (II) sulfide, mercury cadmium, telluride, MoS₂, graphene, and/or any other suitable material(s). In some examples, an array of integrated or discrete CIS or solid-state photodetectors can be used to simultaneously image (e.g., perform optical detection across) the lidar device's entire field of view or a portion thereof. In general, solid-state photodetectors may be configured to detect light having wavelengths between 190 nm (or lower) and 1.4 μm (or higher). PDs and APDs configured to detect light having wavelengths of approximately 905 nm, 1300 nm, or 1550 nm are widely commercially available.

The lidar system 100 may include any suitable combination of measurement technique(s), light source(s), illumination technique(s), and detector(s). Some combinations may be more accurate or more economical on certain conditions. For example, some combinations may be more economical for short-range sensing but incapable of provide accurate measurements at longer ranges. Some combinations may pose potential hazards to eye safety, while other combinations may reduce such hazards to negligible levels.

The control & data acquisition module 108 may control the light emission by the transmitter 104 and may record data derived from the return light signal 114 detected by the receiver 106. In some embodiments, the control & data acquisition module 108 controls the power level at which the transmitter 104 operates when emitting light. For example, the transmitter 104 may be configured to operate at a plurality of different power levels, and the control & data acquisition module 108 may select the power level at which the transmitter 104 operates at any given time. Any suitable technique may be used to control the power level at which the transmitter 104 operates. In some embodiments, the control & data acquisition module 108 or the receiver 106 determines (e.g., measures) particular characteristics of the return light signal 114 detected by the receiver 106. For example, the control & data acquisition module 108 or receiver 106 may measure the intensity of the return light signal 114 using any suitable technique.

Operational parameters of the transceiver 102 may include its horizontal field of view (“FOV”) and its vertical FOV. The FOV parameters effectively define the region of the environment that is visible to the specific lidar transceiver 102. More generally, the horizontal and vertical FOVs of a lidar system 100 may be defined by combining the fields of view of a plurality of lidar devices 102.

To obtain measurements of points in its environment and generate a point cloud based on those measurements, a lidar system 100 may scan its FOV. A lidar transceiver system 100 may include one or more beam-steering components (not shown) to redirect and shape the emitted light signals 110 and/or the return light signals 114. Any suitable beam-steering components may be used including, without limitation, mechanical beam steering components (e.g., rotating assemblies that physically rotate the transceiver(s) 102, rotating scan mirrors that deflect emitted light signals 110 and/or return light signals 114, etc.), optical beam steering components (e.g., lenses, lens arrays, microlenses, microlens arrays, beam splitters, etc.), microelectromechanical (MEMS) beam steering components (e.g., MEMS scan mirrors, etc.), solid-state beam steering components (e.g., optical phased arrays, optical frequency diversity arrays, etc.), etc.

In some implementations, the lidar system 100 may include or be electronically coupled to a data analysis & interpretation module 109, which may receive outputs (e.g., via connection 116) from the control & data acquisition module 108 and perform data analysis functions on those outputs. The connection 116 may be implemented using a wireless or non-contact communication technique.

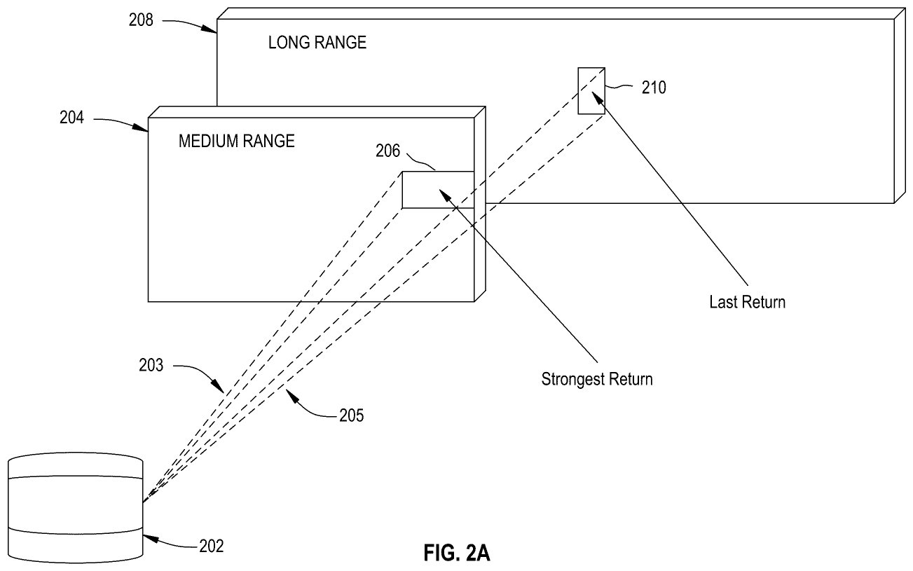

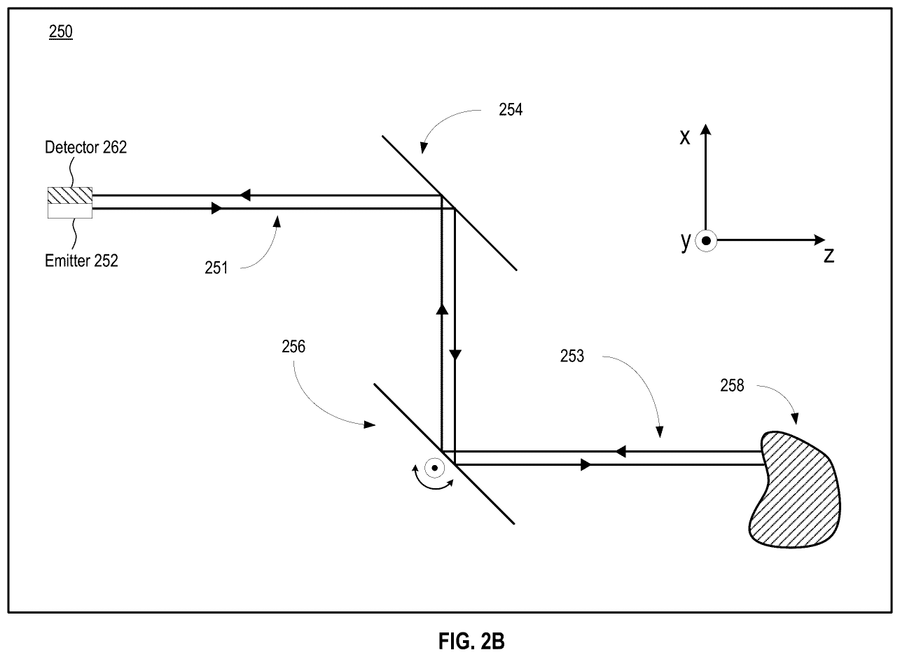

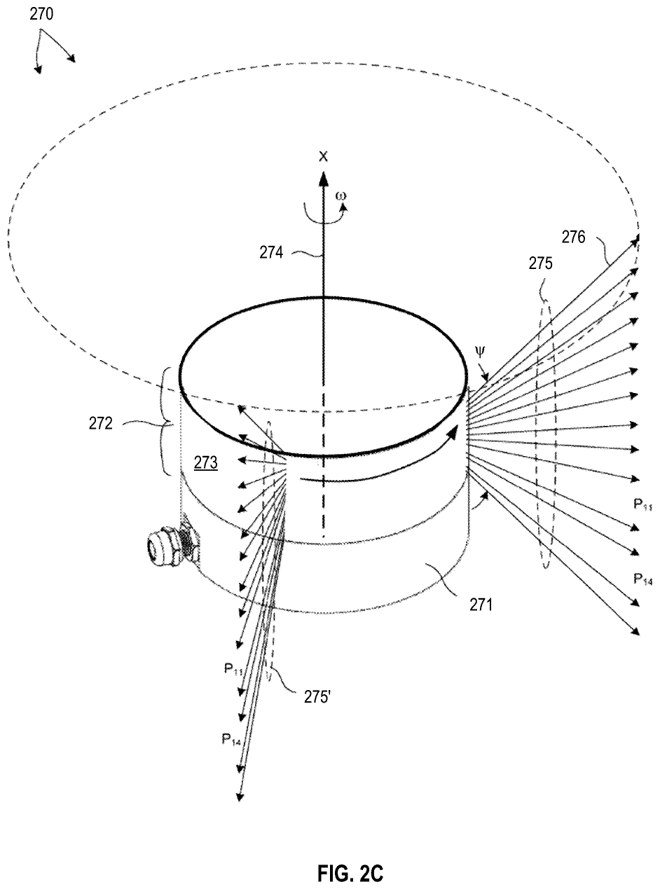

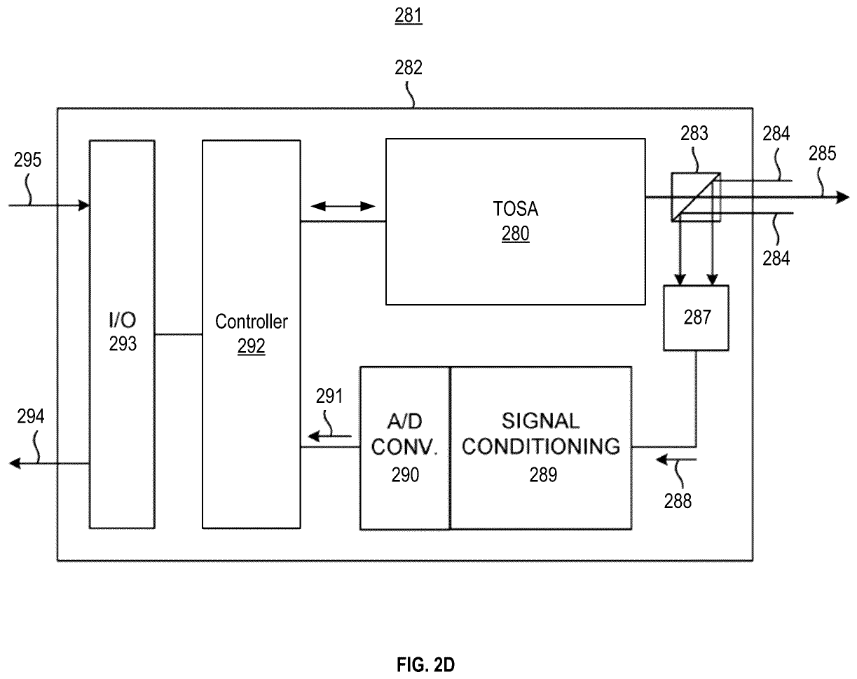

FIG. 2A illustrates the operation of a lidar system 202, in accordance with some embodiments. In the example of FIG. 2A, two return light signals 203 and 205 are shown. Laser beams generally tend to diverge as they travel through a medium. Due to the laser's beam divergence, a single laser emission may hit multiple objects at different ranges from the lidar system 202, producing multiple return signals 203, 205. The lidar system 202 may analyze multiple return signals 203, 205 and report one of the return signals (e.g., the strongest return signal, the last return signal, etc.) or more than one (e.g., all) of the return signals. In the example of FIG. 2A, lidar system 202 emits laser light in the direction of near wall 204 and far wall 208. As illustrated, the majority of the emitted light hits the near wall 204 at area 206 resulting in a return signal 203, and another portion of the emitted light hits the far wall 208 at area 210 resulting in a return signal 205. Return signal 203 may have a shorter TOF and a stronger received signal strength compared with return signal 205. In both single- and multiple-return lidar systems, it is important that each return signal is accurately associated with the transmitted light signal so that one or more attributes of the object that reflect the light signal (e.g., range, velocity, reflectance, etc.) can be correctly calculated.

Some embodiments of a lidar system may capture distance data in a two-dimensional (“2D”) (e.g., single plane) point cloud manner. These lidar systems may be used in industrial applications, or for surveying, mapping, autonomous navigation, and other uses. Some embodiments of these systems rely on the use of a single laser emitter/detector pair combined with a moving mirror to effect scanning across at least one plane. This mirror may reflect the emitted light from the transmitter (e.g., laser diode), and/or may reflect the return light to the receiver (e.g., to the detector). Use of a movable (e.g., oscillating) mirror in this manner may enable the lidar system to achieve 90-180-360 degrees of azimuth (horizontal) view while simplifying both the system design and manufacturability. Many applications require more data than just a 2D plane. The 2D point cloud may be expanded to form a 3D point cloud, in which multiple 2D point clouds are used, each pointing at a different elevation (e.g., vertical) angle. Design elements of the receiver of the lidar system 202 may include the horizontal FOV and the vertical FOV.

FIG. 2B depicts a lidar system 250 with a movable (e.g., rotating or oscillating) mirror, according to some embodiments. In the example of FIG. 2B, the lidar system 250 uses a single emitter 252/detector 262 pair combined with a fixed mirror 254 and a movable mirror 256 to effectively scan across a plane. Distance measurements obtained by such a system may be effectively two-dimensional (e.g., planar), and the captured distance points may be rendered as a 2D (e.g., single plane) point cloud. In some embodiments, but without limitation, the movable mirror 256 may oscillate at very fast speeds (e.g., thousands of cycles per minute).

The emitted laser signal 251 may be directed to a fixed mirror 254, which may reflect the emitted laser signal 251 to the movable mirror 256. As movable mirror 256 moves (e.g., oscillates), the emitted laser signal 251 may reflect off an object 258 in its propagation path. The reflected return signal 253 may be coupled to the detector 262 via the movable mirror 256 and the fixed mirror 254. In some embodiments, the movable mirror 256 is implemented with mechanical technology or with solid state technology (e.g., MEMS).

FIG. 2C depicts a 3D lidar system 270, according to some embodiments. In the example of FIG. 2C, the 3D lidar system 270 includes a lower housing 271 and an upper housing 272. The upper housing 272 includes a cylindrical shell element 273 constructed from a material that is transparent to infrared light (e.g., light having a wavelength within the spectral range of 700 to 1,700 nanometers). In one example, the cylindrical shell element 273 is transparent to light having wavelengths centered at 905 nanometers.

In some embodiments, the 3D lidar system 270 includes a lidar transceiver 102 operable to emit laser beams 276 through the cylindrical shell element 273 of the upper housing 272. In the example of FIG. 2C, each individual arrow in the sets of arrows 275, 275′ directed outward from the 3D lidar system 270 represents a laser beam 276 emitted by the 3D lidar system. Each beam of light emitted from the system 270 may diverge slightly, such that each beam of emitted light forms a cone of light emitted from system 270. In one example, a beam of light emitted from the system 270 illuminates a spot size of 20 centimeters in diameter at a distance of 100 meters from the system 270.

In some embodiments, the transceiver 102 emits each laser beam 276 transmitted by the 3D lidar system 270. The direction of each emitted beam may be determined by the angular orientation ω of the transceiver's transmitter 104 with respect to the system's central axis 274 and by the angular orientation w of the transmitter's movable mirror 256 with respect to the mirror's axis of oscillation (or rotation). For example, the direction of an emitted beam in a horizontal dimension may be determined by the transmitter's angular orientation ω, and the direction of the emitted beam in a vertical dimension may be determined by the angular orientation w of the transmitter's movable mirror. Alternatively, the direction of an emitted beam in a vertical dimension may be determined the transmitter's angular orientation ω, and the direction of the emitted beam in a horizontal dimension may be determined by the angular orientation w of the transmitter's movable mirror. (For purposes of illustration, the beams of light 275 are illustrated in one angular orientation relative to a non-rotating coordinate frame of the 3D lidar system 270 and the beams of light 275′ are illustrated in another angular orientation relative to the non-rotating coordinate frame.)

The 3D lidar system 270 may scan a particular point (e.g., pixel) in its field of view by adjusting the orientation ω of the transmitter and the orientation w of the transmitter's movable mirror to the desired scan point (ω, ψ) and emitting a laser beam from the transmitter 104. Likewise, the 3D lidar system 270 may systematically scan its field of view by adjusting the orientation ω of the transmitter and the orientation w of the transmitter's movable mirror to a set of scan points (ωᵢ, ψⱼ) and emitting a laser beam from the transmitter 104 at each of the scan points.

Assuming that the optical component(s) (e.g., movable mirror 256) of a lidar transceiver remain stationary during the time period after the transmitter 104 emits a laser beam 110 (e.g., a pulsed laser beam or “pulse” or a CW laser beam) and before the receiver 106 receives the corresponding return beam 114, the return beam generally forms a spot centered at (or near) a stationary location LO on the detector. This time period is referred to herein as the “ranging period” or “listening period” of the scan point associated with the transmitted beam 110 and the return beam 114.

In many lidar systems, the optical component(s) of a lidar transceiver do not remain stationary during the ranging period of a scan point. Rather, during a scan point's ranging period, the optical component(s) may be moved to orientation(s) associated with one or more other scan points, and the laser beams that scan those other scan points may be transmitted. In such systems, absent compensation, the location Li of the center of the spot at which the transceiver's detector receives a return beam 114 generally depends on the change in the orientation of the transceiver's optical component(s) during the ranging period, which depends on the angular scan rate (e.g., the rate of angular motion of the movable mirror 256) and the range to the object 112 that reflects the transmitted light. The distance between the location Li of the spot formed by the return beam and the nominal location LO of the spot that would have been formed absent the intervening rotation of the optical component(s) during the ranging period is referred to herein as “walk-off.”

Referring to FIG. 2D, a block diagram of a transmitter-receiver optical subassembly (TROSA) 281 is shown, according to some embodiments. In some embodiments, the TROSA 281 may include a TOSA 280, an optical detector 287, a beam splitter 283, signal conditioning electronics 289, an analog to digital (A/D) converter 290, controller 292, and digital input/output (I/O) electronics 293. In some embodiments, the TROSA components illustrated in FIG. 2D are integrated onto a common substrate 282 (e.g., printed circuit board, ceramic substrate, etc.). In some embodiments, the TROSA components illustrated in FIG. 2D are individually mounted to a common substrate 282. In some embodiments, groups of these components are packaged together and the integrated package(s) is/are mounted to the common substrate.

The TOSA 280 may include one or more light sources and may operate the light source(s) safely within specified safety thresholds. A light source of the TOSA may emit an optical signal (e.g., laser beam) 285.

A return signal 284 may be detected by the TROSA 281 in response to the optical signal 285 illuminating a particular location. For example, the optical detector 287 may detect the return signal 284 and generate an electrical signal 288 based on the return signal 284. The controller 292 may initiate a measurement window (e.g., a period of time during which collected return signal data are associated with a particular emitted light signal 285) by enabling data acquisition by optical detector 287. Controller 292 may control the timing of the measurement window to correspond with the period of time when a return signal is expected in response to the emission of an optical signal 285. In some examples, the measurement window is enabled at the time when the optical signal 285 is emitted and is disabled after a time period corresponding to the time of flight of light over a distance that is substantially twice the range of the lidar device in which the TROSA 281 operates. In this manner, the measurement window is open to collect return light from objects adjacent to the lidar device (e.g., negligible time of flight), objects that are located at the maximum range of the lidar device, and objects in between. In this manner, other light that does not contribute to a useful return signal may be rejected.

In some embodiments, the signal analysis of the electrical signal 288 produced by the optical detector 287 is performed by the controller 292, entirely. In such embodiments, the signals 294 provided by the TROSA 281 may include an indication of the distances determined by controller 292. In some embodiments, the signals 294 include the digital signals 291 generated by the A/D converter 290. These raw measurement signals 291 may be processed further by one or more processors located on board the lidar device or external to the lidar device to arrive at a measurement of distance. In some embodiments, the controller 292 performs preliminary signal processing steps on the signals 291 and the signals 294 include processed data that are further processed by one or more processors located on board the lidar device or external to the lidar device to arrive at a measurement of distance.

In some embodiments a lidar device (e.g., a lidar device 100, 202, 250, or 270) includes multiple TROSAs 281. In some embodiments, a delay time is enforced between the firing of each TROSA and/or between the firing of different light sources within the same TROSA. In some examples, the delay time is greater than the time of flight of the light signal 285 to and from an object located at the maximum range of the lidar device, to reduce or avoid optical cross-talk among any of the TROSAs 281. In some other examples, an optical signal 285 is emitted from one TROSA 281 before a return signal corresponding to a light signal emitted from another TROSA 281 has had time to return to the lidar device. In these embodiments, there may be sufficient spatial separation between the areas of the surrounding environment interrogated by the light signals of these TROSAs to avoid optical cross-talk.

In some embodiments, digital I/O 293, A/D converter 290, and signal conditioning electronics 289 are integrated onto a single, silicon-based microelectronic chip. In another embodiment, these same elements are integrated into a single gallium-nitride or silicon based circuit that also includes components of the TOSA 280 (e.g., an illumination driver). In some embodiments, the A/D converter 290 and controller 292 are combined as a time-to-digital converter.

As depicted in FIG. 2D, return light 284 reflected from the surrounding environment is detected by optical detector 287. In some embodiments, optical detector 287 includes one or more avalanche photodiodes (APDs) and/or single-photon avalanche diodes (SPADs). Any suitable optical detector may be used. In some embodiments, optical detector 287 generates an output signal 288 that is amplified by signal conditioning electronics 289. In some embodiments, signal conditioning electronics 289 include an analog trans-impedance amplifier. However, in general, the amplification of output signal 288 may include multiple amplifier stages. In this sense, an analog transimpedance amplifier is provided by way of non-limiting example, as many other analog signal amplification schemes may be used.

In some embodiments, the amplified signal is communicated to A/D converter 290, and the digital signals generated by the A/D converter are communicated to controller 292. Controller 292 may generate an enable/disable signal to control the timing of data acquisition by ADC 290.

As depicted in FIG. 2D, the optical signal 285 emitted from the TROSA 281 and the return signal 284 directed toward the TROSA 281 share a common path within the lidar device. In the embodiment depicted in FIG. 2D, the return light 284 is separated from the emitted light 285 by a beam splitter 283. The beam splitter may direct the light 285 emitted by the TOSA 280 toward the lidar device's environment, and direct the return light 284 to the optical detector 287. Any suitable beam splitter may be used, including (without limitation) a polarizing beam splitter, nonpolarizing beam splitter, dielectric film, etc.). Some non-limiting examples of suitable beam splitters are described in International Patent Publication No. WO 2017/164989.

### Some Embodiments of Scanning Devices (“Scanners”)

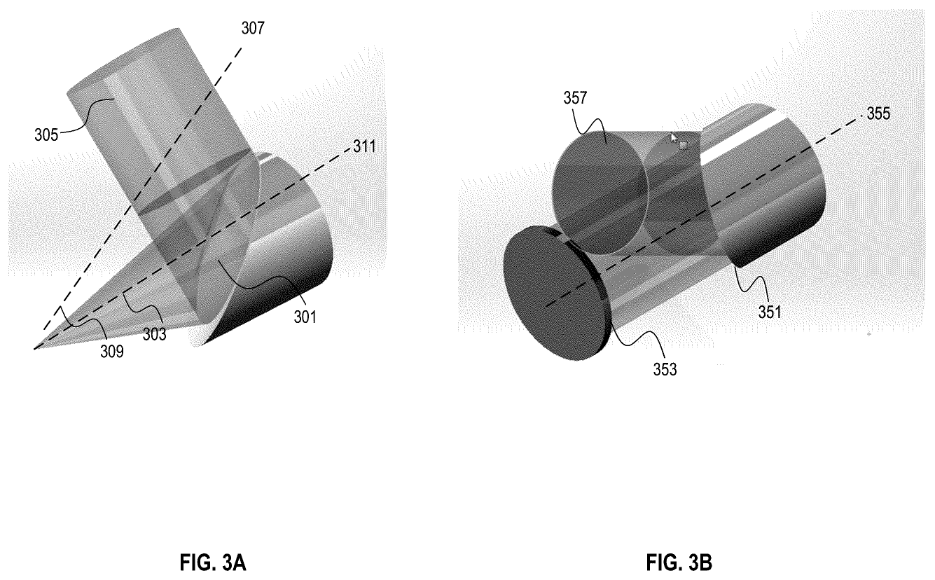

FIG. 3A illustrates a scanning device 300 with an off-axis parabolic mirror 301, according to some embodiments. As illustrated, the off-axis parabolic mirror 301 is a reflector (or deflector) in the shape of a circular paraboloid.

Typically made of a highly reflective material such as aluminum, a complete (or “standard”) parabolic mirror centers on the vertex of the paraboloid. The vertex is the point where the curvature is the greatest and where the paraboloid is symmetrically divided by its axis. A complete parabolic mirror is effective at collecting collimating light and focusing this light to a point, but the receiver often casts a shadow on the paraboloid's vertex. This shadow blocks a significant part of the mirror from reflecting light, resulting in substantial signal loss.

An off-axis parabolic mirror 301 addresses this problem by using a portion of a complete parabolic mirror. Since an off-axis parabolic mirror focuses light onto offset points, outside the collection area, there is no issue with receiver shadowing. An off-axis parabolic mirror can thus have more interactive space around the focus point without obstructing the incoming beam. Depending on how far away from the axis the portion originates, an off-axis parabolic mirror may feature a large or a small angle with great flexibility. This makes an off-axis parabolic mirror a suitable choice for many long-range and precision instrumentation applications including lidar. The unrestricted access to the mirror's focal point also leads to a compact design lidar system.

To allow the off-axis parabolic mirror 301 to work as a scanner to direct the laser emitted by a lidar system (e.g., lidar device 250), an emitter 252 (or optical path of an emitted laser beam) of the lidar system may be placed along the axis 307 of the parabolic mirror 301 at the focal point 309 and directed toward the mirror 301, as illustrated in FIG. 3A. This configuration results in a collimated laser beam 305 after an emitted laser beam 303 is deflected by the parabolic mirror 301, as illustrated in FIG. 3A.

In some embodiments, to allow the off-axis parabolic mirror 301 to direct the emitted laser towards the environment for a 360-degree horizontal scan, the off-axis parabolic mirror 301 may be configured to rotate along a spin axis 311, e.g., by mounting the off-axis parabolic mirror 301 onto a rotational base.

In some embodiments, a 360-degree horizontal scan may be achieved without using an off-axis parabolic mirror 301. FIG. 3B illustrates a scanning device 350, which uses a flat mirror 351 and a collimation lens 353 rather than an off-axis parabolic mirror 301 to achieve a similar 360-degree horizontal scan. Specifically, a laser beam emitted by the emitter of a lidar system may first pass through the collimation lens 353, which collimates the laser beam. The collimated laser beam may be then directed towards the flat mirror 351, which redirects the collimated laser beam towards the environment surrounding the lidar system during a scanning process. If the flat mirror 351 is configurated to rotate about a vertical axis (e.g., axis 355 which may be a vertical axis if the mirror 351 is mounted onto a horizontally laid rotational base), the mirror 351 may then reflect the collimated laser beam 357 towards the environment according to a 360-degree horizontal scan pattern.

### Some Embodiments of Two-Dimensional (“2D”) Lidar Scanning Devices (“Scanners”)

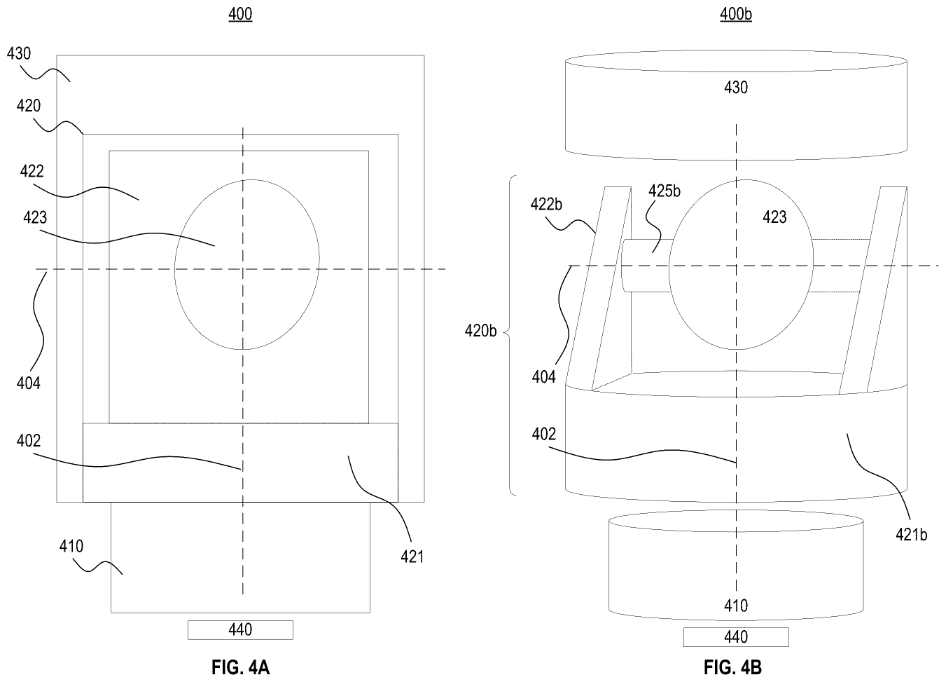

Referring to FIG. 4A, a block diagram of a 2D scanner 400 is shown, according to some embodiments. In some embodiments, the 2D lidar scanner 400 include a rotary component 410, a scan mirror assembly 420, a housing 430, and an orientation sensor 440. In some embodiments, the scan mirror assembly 420 includes a rotational base 421, a mirror-tilting apparatus 422, and a scan mirror 423. Some embodiments of the components of the 2D lidar scanner 400 are described in further detail below.

The 2D scanner 400 may be configured to rotate the scan mirror 423 about a first axis 402 (e.g., a “rotation” axis or “spin” axis, illustrated in FIG. 4A as a vertical axis) and to tilt (e.g., pivot) the scan mirror 423 about a second axis 404 (e.g., a “tilt” axis or “pivot” axis, illustrated in FIG. 4A as a horizontal axis) substantially perpendicular to the first axis. The 2D scanner 400 may rotate the scan mirror 423 in full 360 degree rotations about the first axis. In some embodiments, the 2D scanner 400 is configured to adjust a tilt angle of the scan mirror 423 with respect to the second axis between a range of tilt angles (e.g., between 0 and 90 degrees, between 15 and 75 degrees, between 15 and 60 degrees, between 15 and 45 degrees, etc.). By controlling the orientation of the scan mirror with respect to the first axis and the orientation of the scan mirror with respect to the second axis, the 2D scanner can control the angles of reflection of emitted laser beams and return laser beams (with respect to the surface of the scanning mirror) during a lidar scanning process.

As used herein, two axes of the scanner are “substantially perpendicular” if the angle of intersection between the axes is between 70 and 110 degrees (e.g., 75-105 degrees, 80-100 degrees, 85-95 degrees, 86-94 degrees, 87-93 degrees, 88-92 degrees, 89-91 degrees, 89.5-90.5 degrees, 89.8-90.2 degrees, 89.9-90.1 degrees, or 90 degrees.

In some embodiments, the rotary component 410 of the 2D scanner 400 is coupled to the scan mirror assembly 420 (e.g., to the rotational base 421 of the scan mirror assembly) and operable to apply a driving force to the scan mirror assembly 420 that tends to rotate the scan mirror assembly 420 about the first axis 402. Any suitable rotary component 410 may be used including, without limitation, a brushless motor, brushed motor (e.g., brushed DC motor), AC motor (e.g., brushed or brushless AC motor), pneumatic motor, hydraulic motor, piezo driven motor, combustion motor, steam driven motor, or a pulsed rotary motor. The rotational base 421 may comprise any suitable material or components.

In some embodiments, in response to the application of the first driving force to the scan mirror assembly 420, the mirror-tilting apparatus 422 is configured to apply a second driving force to the scan mirror 423 tending to tilt the scan mirror about the second axis 404. Some non-limiting embodiments of suitable scan mirror assemblies 420 and mirror-tilting apparatus 422 are described in further detail below. In some cases, the mirror-tilting apparatus 422 and the scan mirror 423 may be referred to collectively as the tiltable portion of the scan mirror assembly 420.

In some embodiments, the housing 430 includes a shell that is transparent to light in a range of wavelengths that includes the wavelength(s) of the laser beams reflected by the 2D scanner 400 (e.g., infrared light, light within the range 700 to 1,700 nm, light having wavelengths centered at 905 nm, etc.). In some embodiments, the transparent material may be present on all regions of the housing 430 that are within the field of view of the 2D scanner 400. In some embodiments, the housing 430 (or portions thereof) may be mounted on the scan mirror assembly 420, such that the housing 430 (or portions thereof) rotate about the first axis 402 with the scan mirror assembly 420. In some embodiments, the housing 430 (or portions thereof) may be mounted on the scan mirror assembly 420 such that the housing 430 (or portions thereof) tilt about the second axis 402 with the scan mirror 423.

In some embodiments, the orientation sensor 440 senses an orientation of the scan mirror 423 with respect to the first axis 402 and/or an orientation of the scan mirror 423 with respect to the second axis 404. The sensed orientation of the scan mirror 423 at the time an emitted beam reflects from the surface of the scan mirror 423 may be used to determine the trajectory of the emitted beam in the 2D scanner's environment and/or coordinates of the scan point corresponding to the emitted beam within the 2D scanner's field of view. Likewise, the sensed orientation of the scan mirror 423 at the time a return beam reflects from the surface of the scan mirror 423 may be used to determine the trajectory of the return beam in the 2D scanner's environment and/or coordinates of the scan point corresponding to the return beam within the 2D scanner's field of view. Some non-limiting embodiments of suitable orientation sensors 440 are described in further detail below.

To further illustrate some aspects of the operation of the 2D scanner, FIG. 4B shows a breakout view of an embodiment of a 2D scanner 400b. In the example of FIG. 4B, the 2D scanner 400b includes a rotary component 410, a housing 430, and an orientation sensor 440 as described above with reference to FIG. 4A. In the example of FIG. 4B, the 2D scanner 400b also includes a scan mirror assembly 420b, which includes a rotational base 421b, a mirror-tilting apparatus 422b and a scan mirror 423. In the example of FIG. 4B, the mirror-tilting apparatus 422b includes a movable member 425b.

In some embodiments, the scan mirror 423 is mounted to the movable member 425b. In some embodiments, the scan mirror 423 is mounted to a cradle (not shown) that is mounted to the movable member 425b. The movable member 425b may be configured to tilt about the second axis 404. Any suitable movable member 425b may be used including, without limitation, a set of flexures (or flexure bearing); a rotatable shaft; one or more cables, ropes, or wires; a levitating assembly (e.g., magnetically levitated assembly); etc. In some embodiments, the movable member 425b may be elongate, and the long dimension of the movable member 425b may be aligned with the second axis 404.

Conceptually, a “rotation plane” defined by the first axis and the second axis divides the mirror-tilting apparatus 422b and the scan mirror 423 into two portions. As used herein, the “rotation plane” refers to the plane that is perpendicular to the rotatable shaft of the rotary component 410 (such that the first axis 402 is normal to the plane) and includes the second axis 404. In some embodiments, the mass of the mirror-tilting apparatus 422b and the scan mirror 423 are distributed such that the center of mass of the first portion (of the mirror-tilting apparatus 422b and the scan mirror 423) and the center of mass of the second portion (of the mirror-tilting apparatus 422b and the scan mirror 423) are both positioned in the rotation plane. In some embodiments, the mirror-tilting apparatus 422b includes weights that are configured to position the centers of mass of the first and second portions (of the mirror-tilting apparatus 422b and the scan mirror 423) in the above-described manner.

### 1) Velocity-Responsive 2D Scanner

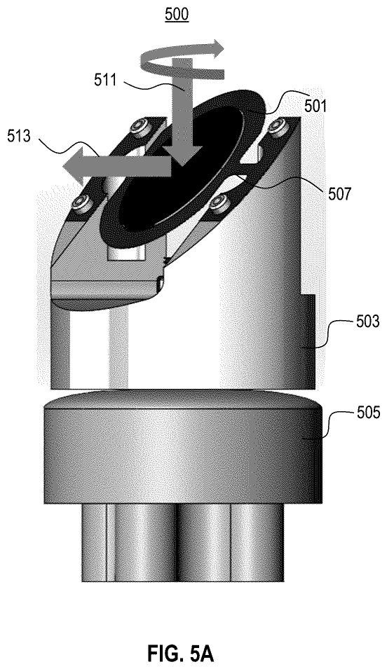

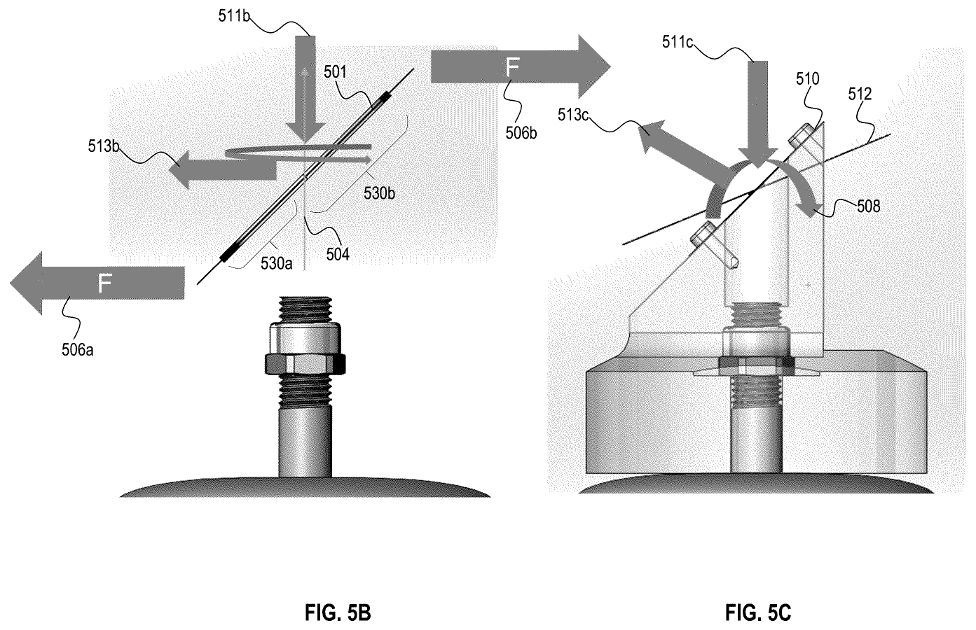

Referring now to FIG. 5A, an exemplary configuration of a two-dimensional scanning device 500 is further illustrated, according to some embodiments. In the example of FIG. 5A, the 2D scanner 500 includes a rotary component 505 (e.g., rotary motor 505) and a scan mirror assembly. The scan mirror assembly includes a scan mirror 501, a rotational base 503, and a mirror-tilting apparatus. The mirror-tilting apparatus includes a pair of flexures 507 (e.g., “flexure bearing”).

The mirror 501 (e.g., off-axis parabolic mirror 301 or flat mirror 351) of the 2D scanner may be mounted on the rotational base 503 to achieve a 360-degree horizontal scan. The rotational base 503 may be driven to rotate about a “spin axis” by a rotary component (e.g., a rotary motor) 505. The spin axis may be substantially orthogonal to a “pivot axis,” and the mirror may be configured to tilt (or “pivot”) about the pivot axis. In the example of FIG. 5A, the spin axis is vertical and the pivot axis is horizontal. The mirror 501 may be mounted on the rotational base 503 through a pair of flexures 507 (e.g., “flexure bearing”) that hold the mirror 501 at a desired orientation (e.g., position and angle) with respect to the rotational base 503. In some embodiments, the mirror may have an initial orientation (or “default orientation”) with respect to the rotational base 503 when the rotational base is not rotating (has an angular velocity of 0 radians). In one example, the initial orientation of the mirror 501 may be a 45-degree angle with respect to the rotation plane, as illustrated in FIG. 5A.

During a scanning process, the mirror 501 may receive a laser beam 511 emitted by the lidar system (e.g., by emitter 252 of the lidar system 250), such that the laser beam 511 is incident on the reflective surface of the mirror 501. When the mirror 501 is mounted at a 45-degree angle with aspect to the spin axis and the emitted laser beam 511 is directed toward the mirror along the spin axis, the mirror 501 can then reflect the emitted laser 511 towards the environment in a horizontal direction (e.g., as a laser beam 513 illustrated in FIG. 5A). The laser beam 511 emitted by the transmitter of the lidar system may be directed towards the mirror 501 with or without passing through a collimating lens, depending on whether the mirror 501 is an off-axis parabolic mirror or a flat mirror as discussed in relation to FIG. 3.

During a scanning process, when the rotational base 503 drives the mirror 501 to rotate about the spin axis, the mirror 501 may direct laser beams 513 towards the environment as the mirror rotates through its 360-degree field of view. If the orientation of the mirror 501 with respect to the spin axis (e.g., the angle of incidence between the emitted laser beam 511 and the mirror 501) does not change during the scanning process, the laser beam 513 may be directed towards the environment along a horizontal direction to achieve a one-dimensional (1D), 360-degree scan.

According to one application, if the maximum range of the above lidar system is 300 m, the time of flight for the lidar system is then ˜2 μs (i.e., 2*300 m/299,792,458 m/s). The maximum serial firing rate for an individual laser emitter of the lidar system may then be approximately 500 kHz (i.e., ½ μs). If the horizontal spot pitch for the lidar system is expected to be 0.2 degrees, then the spinning rate (also referred to as rotation rate or angular velocity) for the rotational mirror 401 may be 278 Hz, according to the following calculation:

$$\frac{500 KHz}{\frac{360 degrees}{0.2 degree}} = 2 77.778 Hz .$$

For a lidar system that has a frame rate of 10 Hz, this means that roughly N=28 (i.e., 277.778/10) scan lines are generated to accommodate the frame rate of 10 Hz and the horizontal spot pitch of 0.2 degrees during a spinning process. If the orientation of the mirror 401 remains unchanged with respect to the spin axis, the N scan lines would be in the same plane, which means that most (e.g., N−1) of the N scan lines may provide little or no additional information about the environment, as these scan lines do not provide an additional field of view due to the repetitive scans in the same scan plane.

One of ordinary skill in the art will appreciate that the maximum range, horizontal spot pitch, and frame rate of a lidar system are design parameters, and that the values of these design parameters can affect the maximum serial firing rate of an individual optical emitter and the number of scan lines N per frame. Nevertheless, to allow the lidar system to more fully utilize its hardware, it is desirable that these N scan lines do not lie in the same plane, but rather in different scan planes having different vertical orientations, such that a 2D scan is achieved. That is, it is desirable to reflect the beams 513 in directions with different vertical orientations, to distribute the N scan lines along the vertical direction, so as to achieve a 2D scan by the lidar system.

As will be described in detail below, the 2D scanners (“scanning devices”) disclosed herein use different working principles to change the orientation of the scan mirror, so as to change the orientations of the reflected beams with respect to the spin axis during a scanning process. According to one embodiment, the scanning device 500 controls the mirror 501 to change its orientation (e.g., its orientation relative to the spin axis) by continually changing the angular velocity of the scan mirror assembly during a scanning process, as further described in detail with reference to FIGS. 5B and 5C.

FIGS. 5B and 5C illustrate a technique for controlling a mirror 501 to change its orientation with respect to a spin axis 504 during a spinning process, according to some embodiments. As illustrated in FIG. 5B, when a mirror 501 mounted onto a rotational base by flexures is driven to rotate about a spin axis 504, forces 506a and 506b (e.g., centrifugal forces) are applied to the left half 530a and the right half 530b of the tiltable portion of the scan mirror assembly (which includes the scan mirror, the mirror-tilting assembly, and any other components of the scan mirror assembly configured to pivot about the pivot axis with the scan mirror). The left half and the right half of the tiltable portion of the scan mirror assembly are separated by a plane (referred to herein as the “dynamic balance plane”) in which both the spin axis and pivot axis are located. The forces 506 operate on the centers of mass of the left and right halves 530 of the tiltable portion of the scan mirror assembly. In the example of FIG. 5B, these centers of mass are not located within a common rotation plane (e.g., a plane that contains the pivot axis and is perpendicular to the dynamic balance plane). Thus, the forces 506a and 506b applied to the left and right halves of the tiltable portion of the scan mirror assembly are additive, such that they apply a torque which tends to flatten the rotating mirror (e.g., tends to change the orientation of the mirror by tilting the mirror about the pivot axis), as indicated by the arrow 508 in FIG. 5C. As can be seen, this tilting of the mirror 501 changes the orientation of the reflected beam 513c relative to the spin axis 504 and relative to the reflected beam 513b, such that 2D scanning is achieved.

As previously described in relation to FIG. 5A, the mirror 501 is also held by the pair of flexures (e.g., spring flexures) from two sides of the mirror 501. The pair of flexures may generate an elastic force that tends to restore the mirror to its default orientation (e.g., at a 45-degree angle with respect to the spin axis). The elastic force generated by the pair of flexures is exerted in the opposite direction of the torque generated by the mirror rotation. Accordingly, the flattening of the mirror 501 is controlled by the torque as well as the elastic force. When these two opposing forces are balanced, the flattening of the rotating mirror stops at a certain orientation (e.g., at a certain angle with respect to the spin axis different from the default angle). For example, during a spinning process, the mirror 501 may move from its original orientation indicated by a line 510 in FIG. 5C to a new orientation indicated by a line 512 in FIG. 5C, when the mirror 501 is controlled to rotate at a certain angular velocity. The orientation change of the mirror 501 caused by the mirror rotation may be also referred to as secondary mirror tilt (or “tilt angle”), where the tilt angle is the angle between the default orientation of the mirror (line 510 in FIG. 5C) and the current orientation of the mirror (line 512 in FIG. 5C).

The orientation at which the mirror's tilt angle stabilizes during a spinning process may be determined based on the generated torque as well as the elastic force, as described earlier. The elastic force generated by the pair of flexures may be determined based on the spring constant of the flexures that hold the mirror 501. The torque generated by the rotation of the scan mirror assembly is determined based on location and magnitude of the centers of mass of the left and right halves of the tiltable portion of the mirror assembly as well as the angular velocity of the rotating mirror. The centrifugal force 506a or 506b may be calculated as follows:

F=mω²r

where m refers to the mass value for the center of mass of the left half or the right half of the tiltable portion of the scan mirror assembly, ω refers to the angular velocity of the scan mirror assembly, and r refers to the distance or offset of the center of mass with respect to the center of the mirror (e.g., the intersection point of the spin axis and the pivot axis).

Accordingly, by controlling the spring constant(s) of the flexures and the mass distribution of the tiltable portion of the mirror assembly, it is possible to control the tilt angle at which the mirror 501 pauses when the scan mirror assembly is controlled to rotate at a specific angular velocity. For example, the larger the spring constant, the less the mirror may tilt at a given rotational velocity. Meanwhile, the larger the offsets (r) and the masses (m) of the centers of mass of the left and right halves of the tiltable portion of the mirror assembly, the more the mirror may tilt at a given angular velocity.

In real applications, once a scanning device is configured for a lidar system, the parameters including the spring constant(s) of the flexures and the mass distribution of the tiltable portion of the mirror assembly generally do not change significantly during a scanning process. Accordingly, to change the tilt angle of the rotating mirror during a scanning process, the torque applied to the tiltable portion of the scan mirror assembly may be changed by increasing or decreasing the angular velocity of the scan mirror assembly. As can be seen from the above equation for the centrifugal force, the torque generated by the rotating mirror 501 is proportional to the square of the angular velocity of the rotating mirror.

Accordingly, by changing the angular velocity of the scan mirror assembly during a scanning process, the tilt angle of the mirror 501 can be changed. If the angular velocity of the scan mirror assembly is continually changed, the tilt angle of the mirror 501 also continually changes. Accordingly, by continually changing the angular velocity of the scan mirror assembly during a scanning process, an additional dimension of scan (which may be also referred to as secondary angular scan) can be achieved, which facilitates 2D scanning of the environment by the scanning device 500.

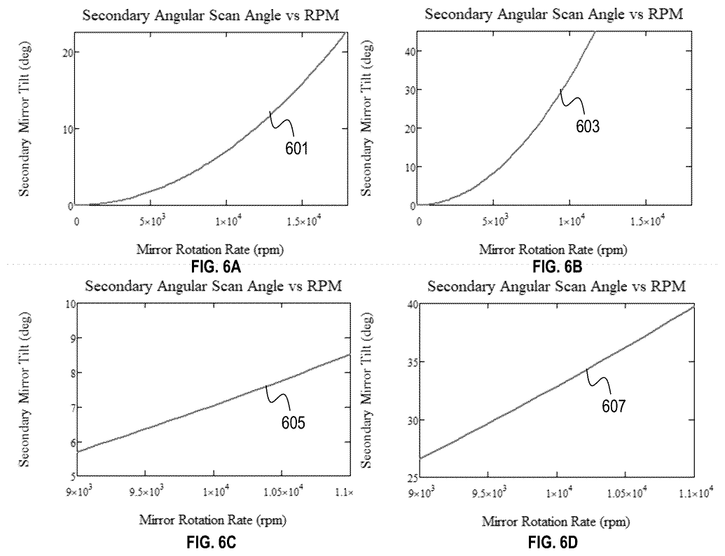

FIGS. 6A-6D further illustrate tilt angle (“secondary angular scan angle”) profiles for different configurations of a 2D scanner 500 over ranges of angular velocities (“RPM”), according to some embodiments. FIG. 6A illustrates one exemplary tilt angle profile for one configuration of a scanning device 500, and FIG. 6B illustrates another exemplary tilt angle profile for a different configuration of the scanning device 500. As can be seen from the curve 601 in FIG. 6A and the curve 603 in FIG. 6B, the tilt angles for these configurations of the scanning device 500 are proportional to the square of the angular velocity of the scan mirror assembly. The differences in the tilt angle profiles of FIG. 6A and FIG. 6B are due to the different parameters of the scanning device configurations, including different spring constants of the flexure bearings, different mass distributions of the tiltable portions of the scan mirror assemblies, etc.

As can be also seen from FIG. 6, the scanning device configuration corresponding to FIG. 6B yields a larger tilt angle at a given angular velocity (RPM) than the scanning device configuration corresponding to FIG. 6B. For the scanning device configuration corresponding to FIG. 6A, the scan mirror has a 22.5-degree tilt angle (relative to the scan mirror's default orientation when the scan mirror assembly is not rotating) when the angular velocity of the scan mirror assembly is 1.8×10⁴ RPM. For the scanning device configuration corresponding to FIG. 6B, the scan mirror has a 42-degree tilt angle when the angular velocity of the scan mirror assembly is 1.2×10⁴ RPM. The observed differences between the tilt angle responses illustrated in FIGS. 6A and 6B are due to the different parameters of the scanning device configurations corresponding to FIGS. 6A and 6B, as described above. For example, the flexures of the scanning device configuration corresponding to FIG. 6B may have a smaller spring constant than the flexures of the scanning device configuration corresponding to FIG. 6B, and/or the mass (m) and offset (r) values of the centers of mass of the left and right halves of the tiltable portion of the scan mirror assembly of the configuration corresponding to FIG. 6B may be greater than the mass (m) and offset (r) values of the configuration corresponding to FIG. 6A.

FIGS. 6C and 6D further illustrate portions of the tilt angle profiles of FIGS. 6A and 6B, respectively. In the examples of FIGS. 6C and 6D, the selected portions of the tilt angle profiles are relatively steep and exhibit an approximately linear relationship between the tilt angle of the scan mirror and the angular velocity of the scan mirror assembly. From FIG. 6C, it can be seen that a +/−10% change in angular velocity (between 0.9×10⁴ RPM and 1.1×10⁴ RPM) generates a change of +/−1.3 degrees in the tilt angle for the scanner device configuration corresponding to FIGS. 6A and 6C. As one of ordinary skill in the art will appreciate, a change of +/−1.3 degrees in the tilt angle of the scan mirror yields a 2.6-degree vertical field of view. Likewise, FIG. 6D shows change in tilt angle of +/−6.5 degrees in response to a +/−10% change in angular velocity for the scanner device configuration corresponding to FIGS. 6B and 6D. As one of ordinary skill in the art will appreciate, a change of +/−6.5 degrees in the tilt angle of the scan mirror yields a 13-degree vertical field of view. Accordingly, by making only a small change in the angular velocity of the scan mirror assembly of a scanning device during a scanning process, a significant increase in the scanning device's vertical field of view can be realized.

Due to the nonlinear relationship (as illustrated in FIGS. 6A and 6B) between the tilt angle of the scan mirror and the angular velocity of the scan mirror assembly, the spot distribution of the laser beams deflected by the scan mirror may be not uniform. In some embodiments, to improve the uniformity of spot distribution, the firing rate of the optical emitter that emits the laser beams 501 can be controlled to compensate for the nonlinear relationship between the tilt angle and the angular velocity of the scan mirror. For instance, the firing rate can be controlled to be lower (less frequent) when the angular velocity is slower during a scanning process, and the firing rate can be controlled to be higher (more frequent) when the angular velocity is faster during the scanning process.

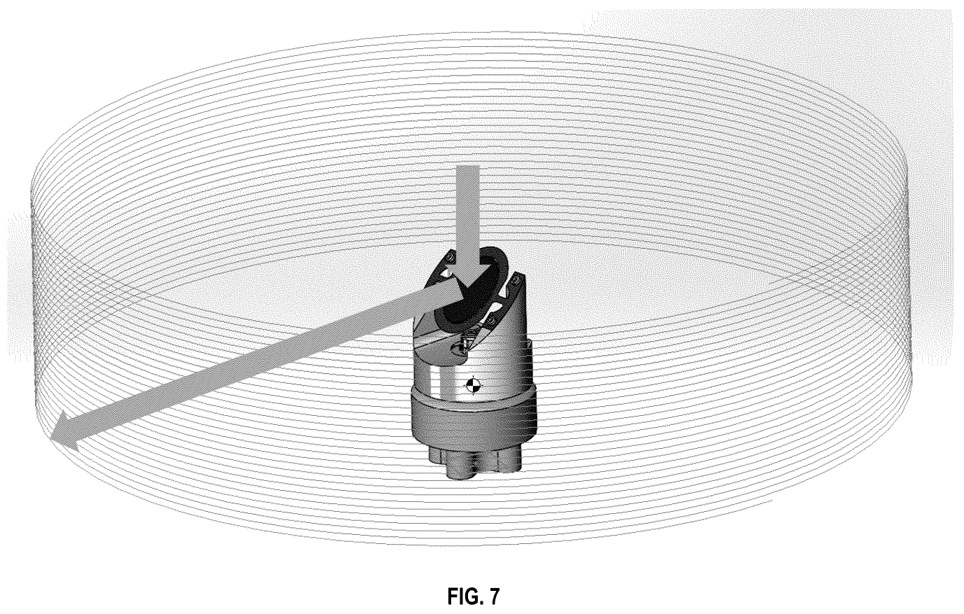

FIG. 7 illustrates an exemplary scan pattern for an embodiment of scanning device 500, according to some embodiments. As illustrated in the figure, the scan pattern can be a helix, such that each scan “line” coincides with a coil of the helix. As can be seen from FIG. 7, the scan pattern and scan coverage (or field of view) for some embodiments of the scanning device 500 are similar to the scan pattern and scan coverage of a conventional multi-channel lidar system that includes multiple channels of optical emitters and detectors. In other words, the scanning device 500 can allow a single-channel lidar system to achieve a scan coverage and scan pattern similar to those achieved by a conventional multi-channel lidar system. However, the cost of manufacturing such a lidar system with a single optical emitter and detector (or a small number of emitters and detectors) can be much lower than the cost of manufacturing such a lidar system with many emitters and detectors. In addition, reducing the number of emitters and detectors of a lidar system also tends to decrease the weight of the lidar system, which facilitates the use of the lidar system in drones or other systems that benefit from a light-weight lidar system with superior capacity or performance. In addition, as previously discussed, some embodiments of the scanning device 500 allow full (or nearly full) utilization of the lidar system's optical emitters and detectors. Additional advantages or features of some embodiments of the scanning device 500 are further described below with reference to specific embodiments.

In some embodiments, the vertical field of view of the scanning device 500 can be dynamically adjusted (e.g., shifted upward or downward) by adjusting (e.g., shifting) the angular velocity range in which the scanning device 500 operates during a scanning process. For example, referring to the scanning device configuration of FIGS. 6B and 6D, if the angular velocity range of the scanning device 500 is initially set between 0.9×10⁴ and 1.1×10⁴ RPM, yielding an initial vertical field of view between −6.5 degrees and +6.5 degrees (centered around a tilt angle of approximately 33.5 degrees), this range can be increased to values between 1.1×10⁴ and 1.3×10⁴ RPM, thereby shifting the vertical field of view upward by 6.5 degrees, such that the adjusted field of view is approximately 0 degrees to +13 degrees. Alternatively, the angular velocity range of the scanning device 500 can be decreased to a range between 0.7×10⁴ and 0.9×10⁴ RPM to shift the vertical field of view downward. That is, embodiments of the scanning device 500 allows dynamic shifting of the vertical field of view (upward or downward) by adjusting the angular velocity range of the scan mirror during a scanning process, which may further prompt its applications in different fields.

Likewise, the height of the vertical field of view of some embodiments of the scanning device 500 can be dynamically adjusted (e.g., increased or decreased) by adjusting (e.g., increasing or decreasing) the angular velocity range in which the scanning device 500 operates during a scanning process. For example, referring to the scanning device configuration of FIGS. 6B and 6D, if the angular velocity range of the scanning device 500 is initially set between 0.9×10⁴ and 1.1×10⁴ RPM, yielding an initial vertical field of view of 13 degrees (centered around a tilt angle of approximately 33.5 degrees), this range can be decreased to values between 0.95×10⁴ and 1.05×10⁴ RPM, thereby decreasing the vertical field of view to approximately 6.5 degrees. Alternatively, the angular velocity range of the scanning device 500 can be increased to a range between 0.8×10⁴ and 1.2×10⁴ RPM to increase the vertical field of view to approximately 26 degrees. That is, embodiments of the scanning device 500 allows dynamic adjustment of the height of the vertical field of view by adjusting the angular velocity range of the scan mirror during a scanning process, which may further prompt its applications in different fields.

For example, for a vehicle equipped with a lidar system containing a scanning device 500, when the vehicle moves to an area that includes high buildings, the scanning device may be controlled to increase its angular velocity range, so as to shift the vertical field of view upward to scan the high buildings. If the vehicle travels to an area with low buildings, the scanning device may be then controlled to decrease its angular velocity range, so as to shift the field of view downward to scan the low buildings.

In some embodiments, the secondary mirror tilt angle of the scanning device 500 is highly deterministic and not sensitive to environment variations. As previously described, once certain parameters (e.g., spring constant of the flexures and mass distribution of the tiltable portion of the scan mirror assembly) are configured for a scanning device, the tilt angle of the scan mirror is then determined based on the angular velocity of the scan mirror assembly. As described earlier, the tilt angle of the scan mirror is proportional to the square of the angular velocity. Any suitable rotary motor that allows precise control of the angular velocity of the scan mirror assembly isolates the scanning device 500 from external perturbations may be used.

In some embodiments, the scanning device 500 may be configured to achieve a unidirectional scanning by steadily increasing or decreasing the angular velocity within the desired angular velocity range and then jumping directly back to the initial angular velocity (the lowest angular velocity in the range) when beginning a new cycle. Alternatively, the scanning device 500 can be configured to achieve bidirectional scanning by continually increasing and decreasing the angular velocity between the upper and lower limits of the angular velocity range.

In some embodiments, the rotary motor that drives the mirror to rotate has a capacity (e.g., has enough torque) to snap down or speed jump within one revolution, so that the angular velocity can restart from the lower limit or the upper limit of the angular velocity range in a unidirectional scan. For a motor configured for bidirectional scanning, such capacity is not necessary since the angular velocity does not require a direct jump from the upper limit to the lower limit, or vice versa, to start a new cycle of scanning.

In some embodiments, to control the mirror to achieve the expected angular velocity acceleration, deceleration, snap-down, or speed jump, the rotary motor that drives the mirror to rotate may be configured to include an optical encoder and coded disk for motion sensing. The optical encoder may emit beams of light toward an encoded ring of the coded disk, and may track the movement of the motor based on analysis of beams of light detected by the optical encoder. Other techniques for sensing the orientation of the motor's shaft (and, therefore, the orientation of the scan mirror assembly) may be used. For instance, certain brushed motors without optical encoders can be used to achieve angular velocities of up to 2×10⁴ RPM.

In some embodiments, the shaft included in the rotary motor can be a hollow shaft due to its higher stiffness and rigidity and its resistance to higher bending moments when compared to a solid shaft. In some embodiments, a properly designed solid shaft can be also used in the rotary motor. It is to be understood that, in real applications, there may be many different designs for the rotary motor that allow precise control of the rotation of the mirror at a predefined rotation pattern without experiencing external perturbations. Accordingly, a desired scan pattern through precise control of the angular velocity of a mirror can be achieved by some embodiments of the scanning device 500.

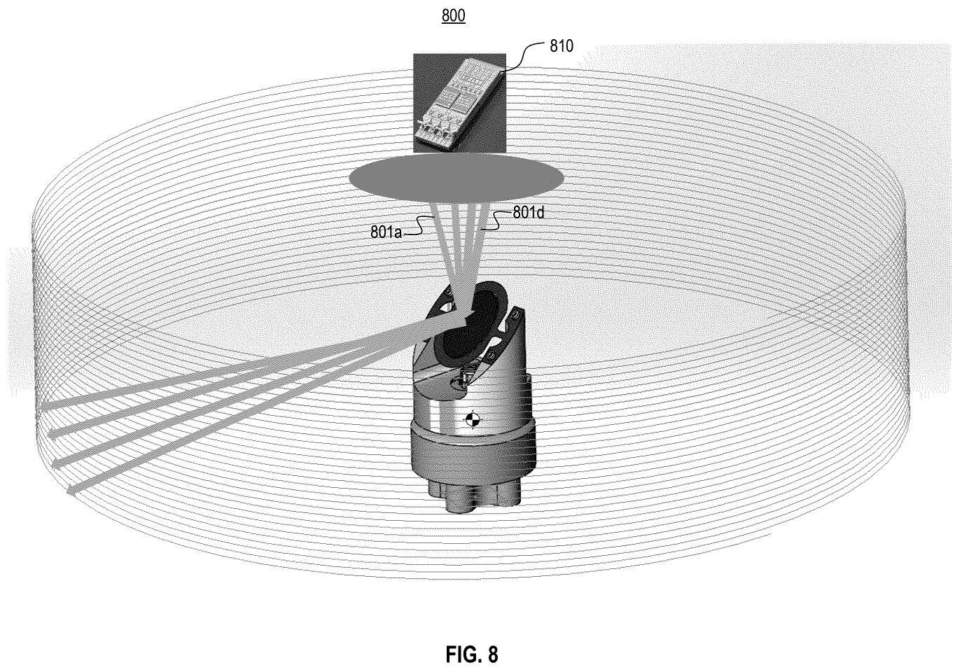

It is also to be understood that while the scanning device 500 has been described in the context of a single-channel lidar system, use of the scanning device 500 is not limited to such lidar systems. In some embodiments, the scanning device 500 can be integrated into a multi-channel lidar system, as further illustrated in FIG. 8.

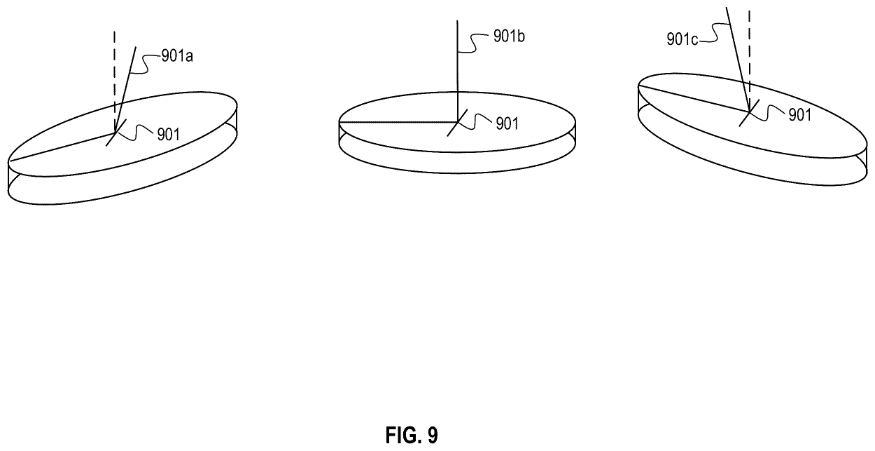

FIG. 8 illustrates the integration of the two-dimensional scanning device 500 into a multi-channel lidar system 800, according to some embodiments. As illustrated in FIG. 8, the multi-channel lidar system 800 may be a four-channel lidar system with four emitters (e.g., integrated into a four-channel TROSA 810) that emit four laser beams 801a-801d. The four laser beams are closely aligned but each emitted laser beam follows a different optical path and the corresponding return laser beams are detected by different photodetectors. Each of the laser beams 801a-801d may be scanned two-dimensionally as described above with reference to a single-channel lidar system. For example, for a channel that emits laser along the spin axis, the emitted laser beam may achieve a similar orthogonal scan pattern as described above for the single-channel lidar system. On the other hand, for the channels of laser beams that are not emitted long the spin axis of the mirror, the scan pattern may be different, as further described in detail with reference to FIG. 9. For example, in contrast to the idealized scan pattern of tilted helical coils shown in FIG. 8, the actual scan pattern exhibited by multi-channel lidar system 800 may resemble a set out-of-phase cylindrical sinusoids.

In FIG. 9, three laser beams 901a-901c are emitted from a multi-channel lidar system in different directions towards the mirror 901, with only one beam 901b being emitted towards the mirror 901 along the spin axis. The scan pattern for the laser beam 901b is similar to the above-described orthogonal scan pattern of the single-channel lidar system, as shown in the middle part of FIG. 9. For laser beams 901a and 901c, however, their scan patterns differ somewhat from the scan pattern for the laser beam 901b. As can be seen from the left and rights parts of FIG. 9, the scan patterns for the laser beam 901a and 901c resemble helixes, but the helixes are tilted. In addition, the two helixes are tilted in opposite directions at a same time point during the scanning process, as can be seen from the figure. If scan patterns of the laser beams 901a-901c are combined, the overall scan pattern for the multi-channel lidar system flips every 180 degrees due to the oppositely tilted helixes for laser beams 901a and 901c. In addition, the scan patterns of the laser beams 901a-901c may overlap in certain areas at least due to the flipping, and thus the field of view generated by the multi-channel lidar system may be compressed.

While the scan pattern of a three-channel lidar system is illustrated in FIG. 9, the above-described scan patterns can be applied to multi-channel lidar systems having any number (e.g., 4, 8, 16, 32, 1-128, etc.) of channels. These multi-channel lidar systems with different numbers of channels may exhibit field of view compression and the flipping of the scan pattern every 180 degrees, similar to the three-channel lidar system.

### 2) 2D Scanning Based on Changing Angular Acceleration (“Jerk”)

As described above, the scanning device 500 changes the tilt of the scan mirror by changing the angular velocity of the scan mirror assembly. Next, additional embodiments of 2D scanning devices 400 are further described, which change the tilt of the scan mirror by changing the angular acceleration (also referred to as jerk) of the scan mirror assembly. In some embodiments, the changes in angular acceleration are applied to the scan mirror assembly without changing the velocity of the scan mirror assembly by more than a threshold amount (e.g., +/−0.5%, 0.1%, 0.05%, or 0.01%).

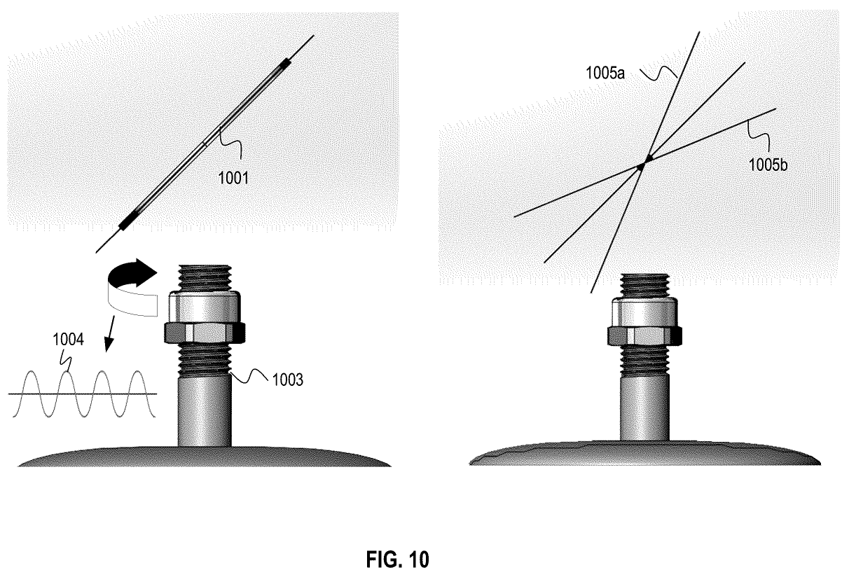

Referring to FIG. 10, principles of jerk-responsive control of the tilt of a scan mirror 1001 are illustrated, according to some embodiments. In the example of FIG. 10, a pulsed rotary motor drives a scan mirror assembly to rotate with a time-varying angular acceleration 1004, thereby causing a time-varying torque to be applied to the tiltable portions of the scan mirror assembly. The time-varying torque drives the scan mirror 1001 included in the scan mirror assembly to tilt, thereby facilitating a 2D scan.

For instance, in FIG. 10, a mirror 1001 within an appropriately designed mirror assembly (not shown) is mounted on a rotating portion of a pulsed rotary motor 1003 (e.g., a brushless motor, etc.). When the pulsed rotary motor 1003 rotates at a certain frequency (e.g., 10 Hz or any other suitable frequency) with a specified pattern (e.g., with a changing angular acceleration as shown by the waveform 1004 in FIG. 10), the motor 1003 may drive the mirror 1001 to rotate with a time-varying angular acceleration (“jerk”). The time-varying angular acceleration of the scan mirror assembly causes a time-varying torque to be applied to the tiltable portion of the scan mirror assembly, thereby causing the tilt angle of the scan mirror to change (e.g., between orientations 1005a and 1005b as illustrated in FIG. 10). In this manner, 2D scanning is achieved.

### 3) Resonance-Based Jerk-Responsive 2D Scanner (First Embodiment)

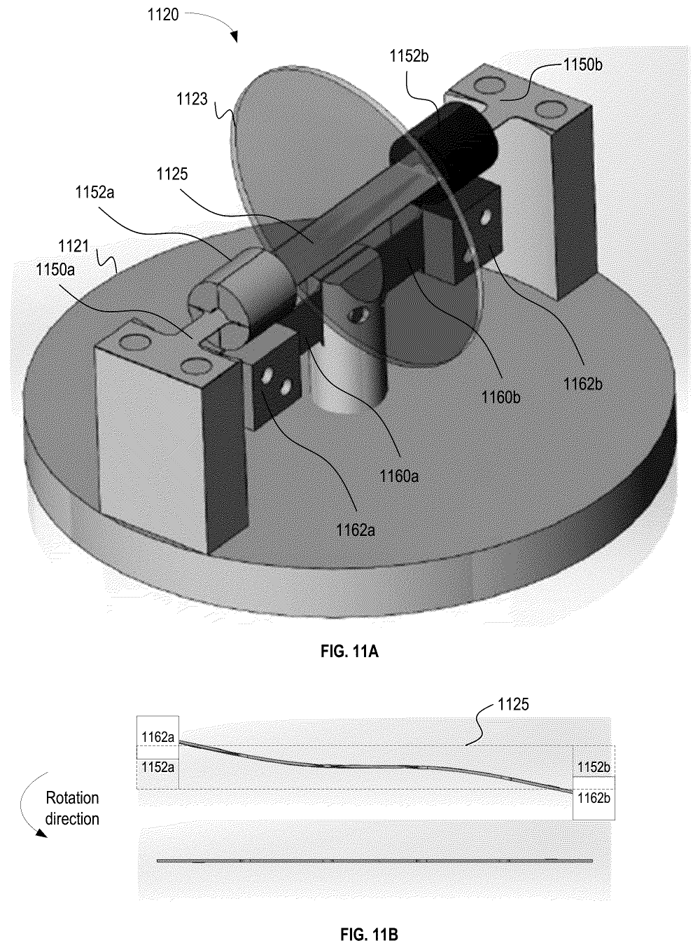

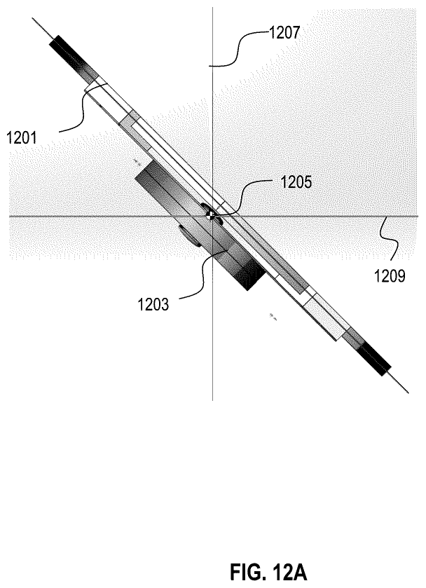

FIG. 11A illustrates one exemplary architecture of a scan mirror assembly 1120 for a jerk-responsive 2D scanner 1100, according to some embodiments. In the example of FIG. 11A, the scan mirror assembly 1120 includes a rotational base 1121, a scan mirror 1123, and a mirror tilting apparatus. The mirror tilting apparatus includes a pair of flexures 1150, a pair of magnetic bearings 1152, and a movable member 1125 (e.g., a rotatable shaft). The scan mirror 1123 is coupled (e.g., affixed) to the movable member 1125. The movable member 1125 is coupled to the rotational base 1121 via the magnetic bearings 1152 and the spring flexures 1150. Each of the magnetic bearings may include a north-south magnetic pair.

In addition, the scan mirror assembly 1120 includes a pair of flexible members 1160 (e.g., spring arms). Balanced weights 1162 are suspended on the flexible members. In some embodiments, the weights 1162 may be aligned under the magnetic bearings 1152, and the weights 1162 (or the upper portions of the weights 1162) may be magnetic. For example, the upper portion of each of the weights 1162 may include a north-south magnetic pair. Collectively, the flexible members 1160 and the balanced weights 1162 may be referred to herein as a “jerk-transfer assembly,” which operates to transform a jerk force applied to the scan assembly 1120 into a magnetic force that drives the magnetic bearings 1152 to rotate, thereby causing the tilt angle of the scan mirror 1123 to change.

When the rotational base 1121 spins or rotates at a constant angular velocity or with a constant angular acceleration, the scan mirror 1123 may remain at a stable, default tilt angle. In this scenario, no jerk force is applied to the scan mirror assembly 1120, the net torque acting on the left arm (1160a, 1162a) and right arm (1160b, 1162b) of the jerk-transfer assembly is zero, and the weights 1162 remain aligned under the magnetic bearings 1152. Thus, the magnetic bearings remain stable (non-rotating).

However, when the angular acceleration of the scan mirror assembly 1120 changes at a time-varying rate (e.g., when the pulsed rotary motor applies a jerk force to the scan mirror assembly 1120), the angular positions of the weights 1162 with respect to the spin axis may lag behind the angular positions of the magnetic bearings 1152, as shown FIG. 11B. The lagging-behind of the weights 1162 is mainly due to the inertia of the weights and the limitations on the ability of the spring arms 1160 to transfer force from the pulsed rotary motor to the weights when the rotational base 1121 jerks. When the weights 1162 lag behind the magnetic bearings 1152, the magnets in the upper portions of the weights tend to exert magnetic forces on the magnetic bearings 1152, which cause the magnetic bearings 1152 to rotate, thereby tilting the mirror.

In some embodiments, the jerk-transfer assembly may have one or more resonant frequencies, which may be determined by the parameters of the spring arms (e.g., spring constants, length) and the parameters of the weights (e.g., mass, mass distribution, etc.). When jerk forces are applied to the scan mirror assembly 1120 at a resonant frequency of the jerk-transfer assembly, a significant deflection of the weights relative to the magnetic bearings may be observed. Thus, relatively small jerk forces applied to the scan mirror assembly 1120 at a resonant frequency of the jerk-transfer assembly can produce significant and controllable changes in the tilt angle of the scan mirror, which can be sustained will maintaining a constant (or near-constant) angular velocity. In this way, the tilt angle of the scan mirror may be adjusted within a range of angles to scan the vertical field of view as the scan mirror assembly rotates.

It is to be understood that the extent of the change in the tilt angle of the scan mirror is sensitive to the magnitude of the jerk force applied to the scan mirror assembly.

### 4) Resonance-Based Jerk-Responsive 2D Scanner (Second Embodiment)

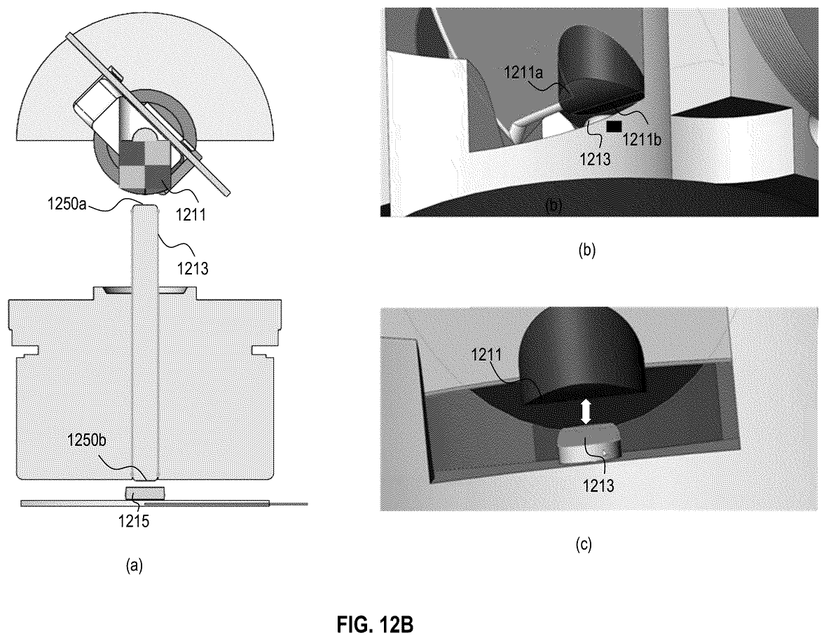

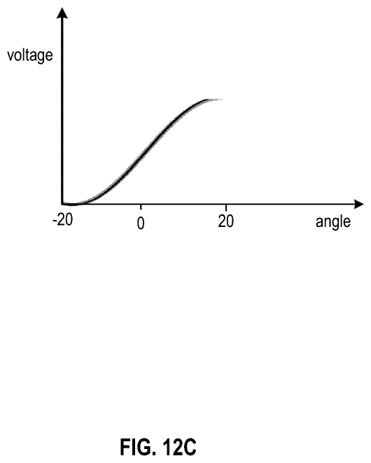

In some cases, it is desirable to integrate the jerk-transfer mechanism directly into the scan mirror and mirror-tilting apparatus, rather than relying on a jerk-transfer assembly separate from the scan mirror and mirror-tilting assembly (as in the scan mirror assembly 1120). Some embodiments of resonance-based jerk-responsive scan mirror assemblies having jerk-transfer mechanisms integrated into the scan mirror and/or mirror tilting assembly are described below with reference to FIGS. 12-16.

FIGS. 12-16 illustrate techniques and mechanisms for balancing the scan mirror assembly (e.g., for adjusting the locations of the centers of mass of portions of the scan mirror assembly, such that the mirror-tilting apparatus of the scan mirror function as an integrated jerk-transfer mechanism), according to some embodiments. As described earlier with reference to FIG. 5, a scan mirror 501 of a scan mirror assembly 500 may experience a torque and tilted orientation when rotated at a constant angular velocity. In some embodiments, balancing the scan mirror assembly (e.g., using one or more of the techniques disclosed herein) may not only integrate the jerk-transfer mechanism into the scan mirror and mirror-tilting apparatus, but also prevent a net torque from operating on the scan mirror in the absence of a jerk force.

Referring again to the scan mirror assembly 500 of FIG. 5, one of ordinary skill in the art will appreciate that the center of mass of the scan mirror 501 is located approximately at the center of the scan mirror 501, halfway between the scan mirror's front surface (which is reflective) and back surface (which is mounted to the flexures 507). FIG. 12A illustrates a mechanism for aligning the center of mass of a scan mirror 1201 (e.g., scan mirror 501) with the springs formed by the flexures 507. This alignment can be achieved by placing a counterweight 1203 under the center of the mirror, as illustrated in FIG. 12A. In some embodiments, the counterweight (or a portion thereof) is magnetic, which facilitates the use of the counterweight as an indicator of the scan mirror's orientation (as described in further detail below).

FIG. 12B illustrates one exemplary configuration of a scanning device capable of monitoring the mirror orientation during a scanning process. According to the embodiment shown in FIG. 12B, a magnet 1211 (e.g., attached to the back surface of the scan mirror 1201 as part of a counterweight) may be disposed over a first end 1250a of a ferrous motor shaft 1213, such that a magnetic sensor 1215 disposed at the other end 1250b of the shaft 1213 can sense fluctuations in the polarity and strength of the magnetic field generated by the magnet 1211 at the first end 1250a of the shaft. In some embodiments, the magnet 1211 is a single-pole magnet. In some embodiments, the magnet 1211 is a multi-pole magnet (e.g., a multi-pole magnet having an even number of poles). For example, the magnet 1211 may be a split magnet with a north pole and a south pole. In the example of FIG. 12B, the magnet 1211 is a four-pole magnet having two pairs of south and north poles arranged as shown in Parts (a) and (b) of FIG. 12B. Only one south pole and one north pole 1211a and 1211b are shown in Part (b) of FIG. 12B, because the other south pole and north pole of the magnet are hidden from view. The ferrous motor shaft 1213 may contain a highly magnetizable material, such as a suitable grade of steel. The ferrous motor shaft 1213 may be integrated into the rotary motor. When the mirror rotates, the strength and/or polarity of the magnetic field at the first end 1250 of the shaft 1213 can change. For example, when the mirror tilts at different tilt angles, the magnet 1211 may move further away from or closer to the ferrous motor shaft 1213, as can be seen more closely in Part (c) of FIG. 12B.

Thus, the polarity and the magnetic field formed between the magnet 1211 and the ferrous motor shaft 1213 fluctuates, and these fluctuations can be sensed by the magnetic sensor 1215. The magnetic sensor 1215 may include any suitable components, for example, one or more coils, Reed switches, Hall effect sensors (or “Hall sensors”), magneto-resistive elements (MRs) (e.g., semiconductor MRs, anisotropic MRs, giant MRs, tunnel MRs, etc.), etc. The sensed change in the magnetic field can be reflected by a change in the output (e.g., output voltage) of the magnetic sensor 1215. FIG. 12C illustrates one exemplary profile for the tilted angle of the mirror vs. the output voltage of the magnetic sensor 1215. In the plot, the 0 degree position on the x-axis corresponds to a tilt angle of 0 degrees, and the +/−20 degree positions on the x-axis corresponds to tilt angles of +/−20-degrees.

It is to be understood that the above-described mirror orientation sensor illustrated in FIG. 12B can be applied to other embodiments of 2D scanning devices in the present disclosure. In some embodiments, the mirror orientation values detected in this way can be further used to adjust the mirror orientation through a feedback control mechanism, which facilitates precise control of the scanning pattern achieved by the 2D scanning devices.

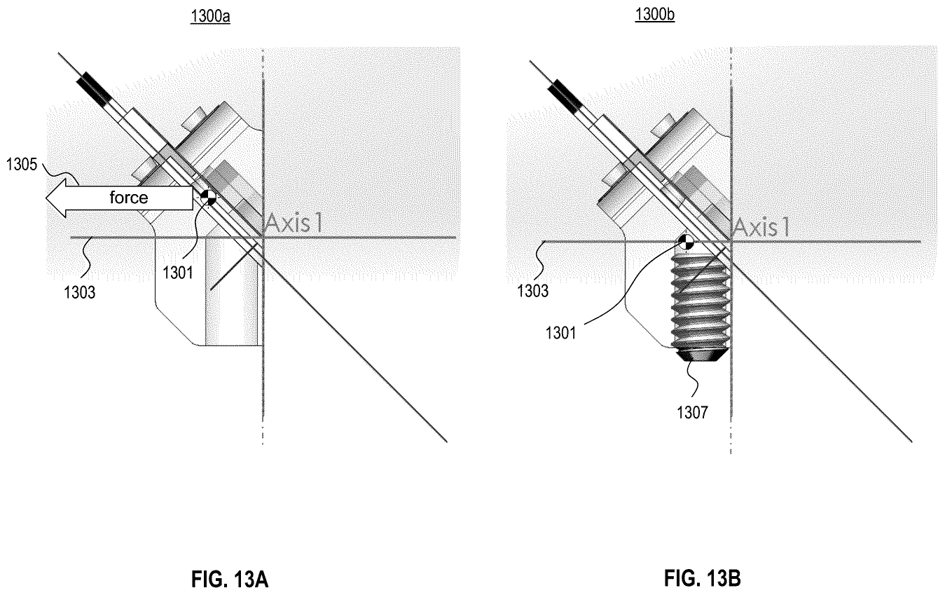

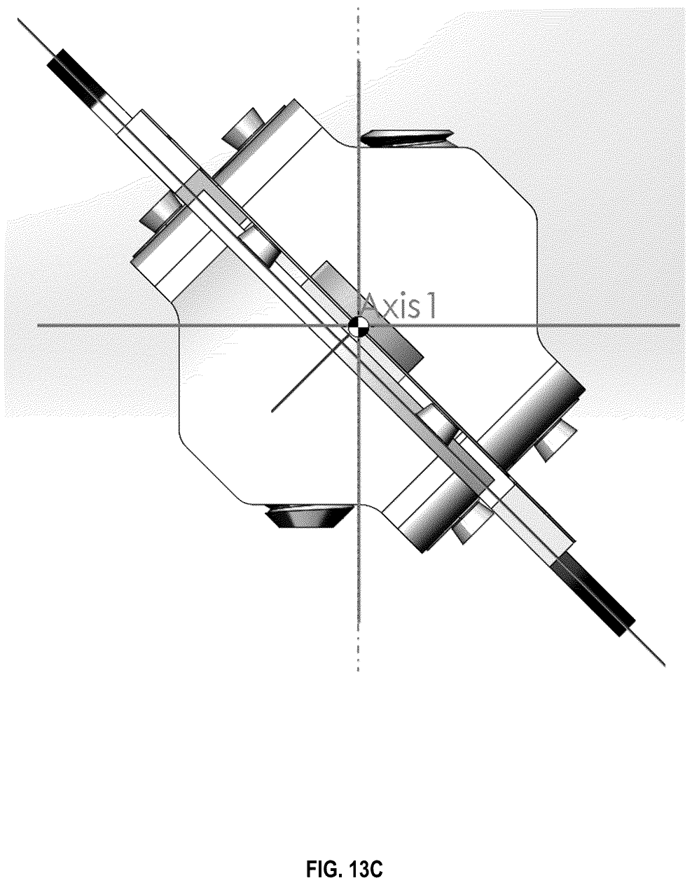

Referring again to the conversion of the 2D scanning device 500 into a jerk-responsive 2D scanning device with the jerk-transfer mechanism integrated into the mirror-tilting apparatus, FIGS. 13A and 13B illustrate a mechanism for aligning the center of mass of a portion of the scan mirror assembly 500 to the rotation plane, according to some embodiments. Referring to FIG. 5A, the dynamic balance plane defined by the pivot axis and the spin axis divides the tiltable portion of the scan mirror assembly into two halves. FIGS. 13A and 13B show a cross-sectional side view of one half 1300 of the tiltable portion of the scan mirror. As illustrated in FIG. 13, the half 1300 of the tiltable portion of the scan mirror assembly may have a center of mass 1301 located away from the rotation plane (spin plane) 1303 if the scan mirror assembly is not balanced. In this unbalanced configuration, rotation of the scan mirror assembly at a constant angular velocity tends to cause the mirror to tilt due to the torque generated by the force 1305 (e.g., centrifugal force), as described above with reference to FIG. 5. However, as illustrated in FIG. 13B, a counterweight 1307 may be attached to the tiltable half 1300 to align its center of mass 1301 in the rotation plane 1303. In the example of FIG. 13B, the counterweight 1307 includes a screw, which provides fine-grained control of the counterweight's position and, therefore, fine-grained control of the position of the tiltable half's center of mass. Likewise, the center of mass of the other half of the tiltable portion of the scan mirror assembly may be balanced (aligned in the spin plane 1303) by adding another counterweight to the other half of the tiltable portion. When the centers of mass of the two halves of the tiltable portion are aligned in the spin plane, the application of jerk force to the scan mirror assembly still operates to control the tilt of the scan mirror , but rotating the scan mirror at a constant angular velocity or with a constant angular acceleration may not affect the tilt of the scan mirror.

FIG. 13C provides a cross-sectional side view of a scan mirror assembly that has been balanced using the above-described techniques, according to some embodiments. The illustrated scan mirror assembly may be further mounted onto the shaft of a rotary motor, which then rotates the scan mirror assembly to scan in one direction and applies jerk force to the scan mirror assembly to tilt the scan mirror, thereby scanning in the substantially orthogonal direction.

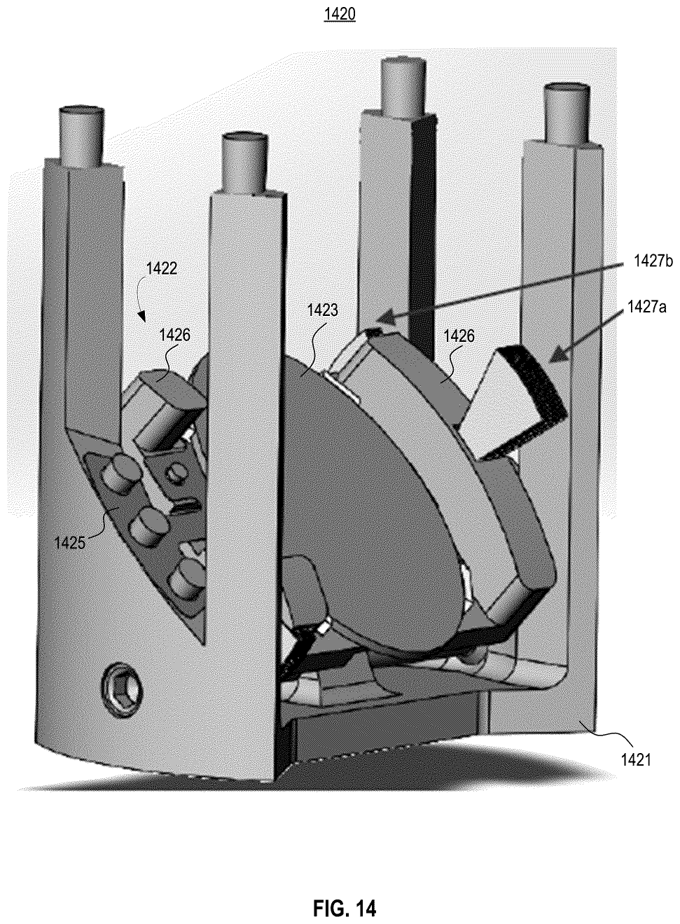

Referring to FIG. 14, another example of a scan mirror assembly 1420 is shown, according to some embodiments. The scan mirror assembly 1420 includes a rotational base 1421, a mirror-tilting apparatus 1422, and a scan mirror 1423. The mirror tilting apparatus 1422 includes flexures 1425 and a cradle 1426. The scan mirror 1423 is mounted to the cradle 1426, and the cradle 1426 is coupled to the rotational base 1421 by the flexures 1425. Counterweights 1427 are affixed to the cradle 1426 to balance the scan mirror assembly 1420.

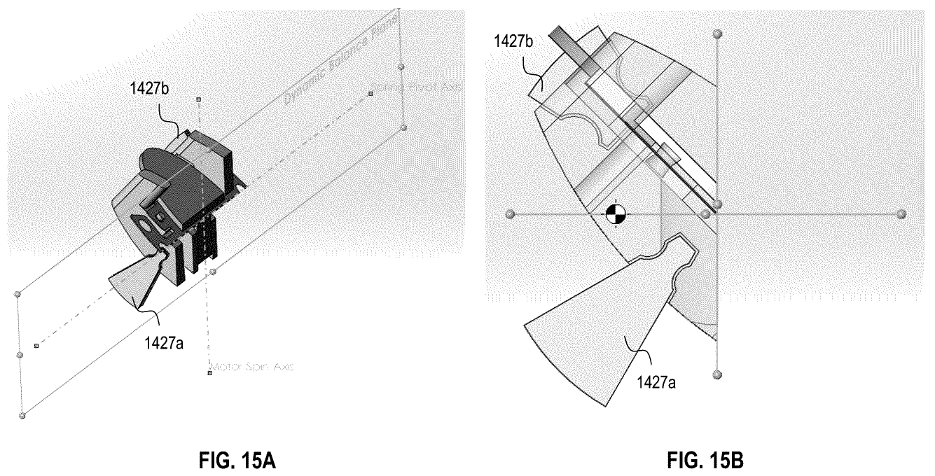

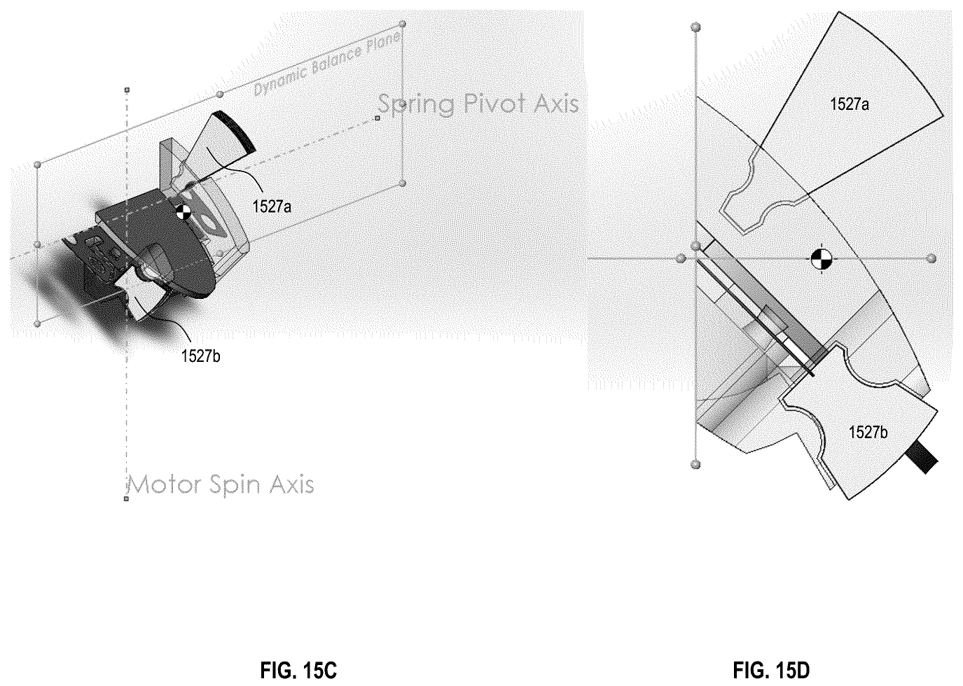

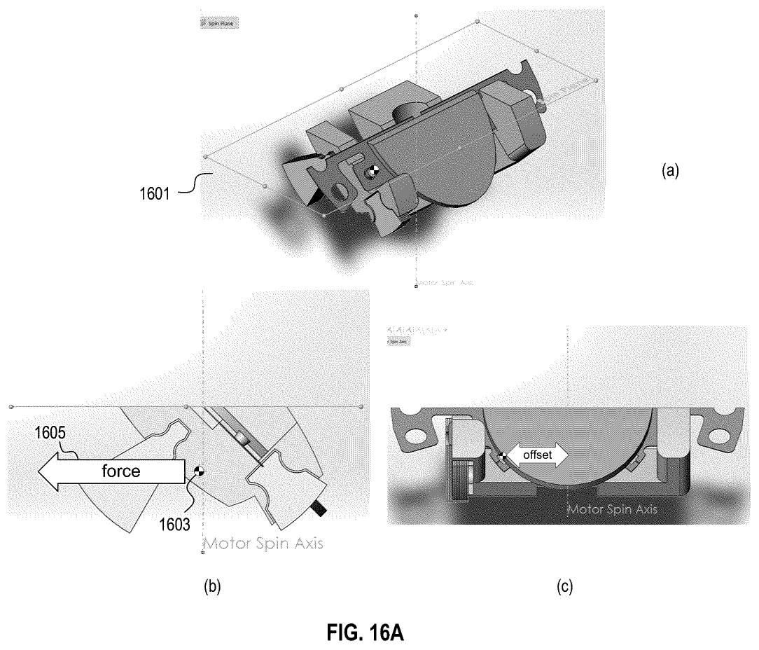

FIGS. 15A and 15B illustrate a counterweight arrangement for the “left half” of the tiltable portion of the scan mirror assembly 1420, according to some embodiments. As illustrated in the FIGS. 15A and 15B, the counterweight arrangement for the left half of the tiltable portion of the scan mirror assembly 1420 may include two separate counterweights (1427a, 1427b) affixed to the cradle at different positions. In some embodiments, the counterweight 1427a is affixed to the left side of the cradle, and the counterweight 1427b is affixed to the right side of the cradle. With the counterweights 1427 affixed, the center of mass of the left half of the tiltable portion of the scan mirror assembly may be disposed in the spin plane. The counterweights 1427 may be referred to as jerk masses, as they are configured for jerk-based actuation of the scan mirror.

In some embodiments, each counterweight 1427 contains multiple similar pieces, where each piece of a counterweight 1427 may be a piece of heavy metal (e.g., a tungsten shim) that has a predefined shape that fits snugly in a receptacle formed in the cradle. In some embodiments, the shapes of the counterweights 1427a and 1427b may be different. In some embodiments, the number of pieces of counterweights 1427a and 1427b may be different.

As further illustrated in FIGS. 15C and 15D, counterweights (1527a, 1527b) may be affixed to the “right half” of the tiltable portion of the scan mirror assembly 1420 to align the center of mass of the right half of the tiltable portion of the scan mirror assembly 1420 in the spin plane. When the centers of mass of the two halves of the tiltable portion of the scan mirror assembly are aligned in the spin plane, the application of jerk force to the scan mirror assembly operates to control the tilt of the scan mirror, but rotating the scan mirror at a constant angular velocity or with a constant angular acceleration may not affect the tilt of the scan mirror.

It is to be understood that the exact number of weights and the exact shape of each weight are not limited to the structure illustrated in FIG. 15 or the above-described arrangements. Other shapes and numbers of weights are also possible, as long as the weights align the centers of mass of the two halves of the tiltable portion of the scan mirror assembly in the rotation plane.

It is also to be understood that the weights disclosed herein are preferably placed such that they do not cross over to the other side of the dynamic balance plane as the mirror tilts. If a weight crosses over the dynamic balance plane, the centrifugal forces no longer balance and the system may cease to operate properly. Hence, in some embodiments, all balance weights are placed along 45-degree or 135-degree lines. This arrangement may maximize the amount of jerk for a given mass without risking the system becoming unstable and “tipping over” the dynamic balance plane.

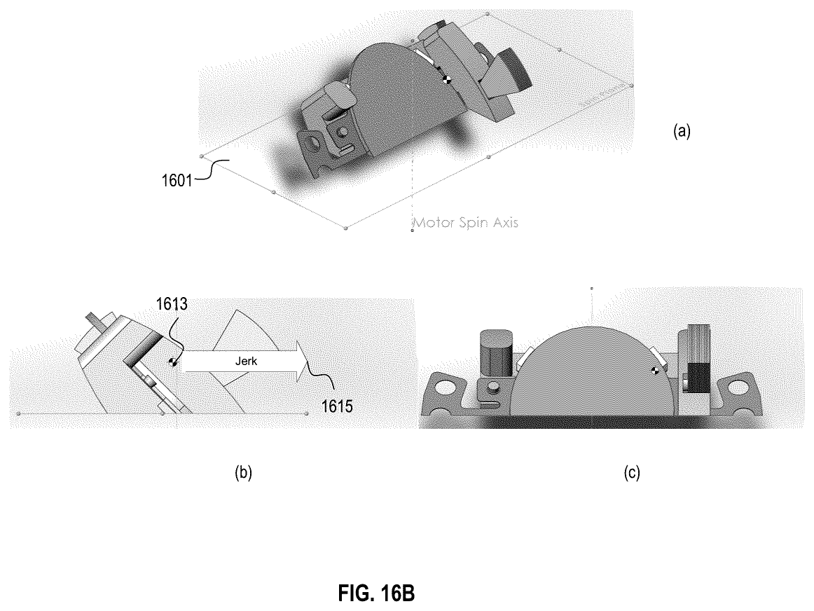

FIGS. 16A and 16B illustrate the effects of applying a jerk force to the scan mirror assembly 1420. In the example of FIGS. 16A and 16B, the “bottom half” and the “top half” of the tiltable portion of the scan mirror assembly are divided by the rotation plane 1601 rather than the dynamic balance plane. Specifically, FIG. 16A illustrates different views of the bottom half of the tiltable portion of the scan mirror assembly, according to some embodiments. The center of mass 1603 of the bottom half is also below the rotation plane 1601, as illustrated in Part (b) of FIG. 16A. In addition, as illustrated in Parts (a)-(c) of FIG. 16A, the center of mass is also shifted to the left of the spin axis (e.g., an offset illustrated in Part (c)). Accordingly, when there is a change in the angular acceleration of the scan mirror assembly (e.g., when a jerk force is applied to the scan mirror assembly), a net force 1605 acts on the center of mass 1603 of the bottom half, resulting in a torque on the flexures that couple the scan mirror to the rotational base of the scan mirror assembly, as illustrated in Part (b) of FIG. 16A.

FIG. 16B illustrates different views of the top half of the tiltable portion of the scan mirror assembly, according to some embodiments. The center of mass 1613 of the top half is also above the rotation plane 1601, as illustrated in Parts (a)-(c) of FIG. 16B. In addition, as illustrated in Part (c) of FIG. 16B, the center of mass 1613 is shifted to the right of the spin axis (e.g., an offset illustrated in Part (c)). Accordingly, when there is a change in the angular acceleration of the scan mirror assembly (e.g., when a jerk force is applied to the scan mirror assembly), a net force 1615 acts on the center of mass 1613 of the top half, resulting in a torque on the flexures that couple the scan mirror to the rotational base of the scan mirror assembly, as illustrated in Part (b) of FIG. 16B.

As can be seen from FIGS. 16A-16B, the torque 1605 generated under the rotation plane and the torque 1615 generated over the rotation plane are additive, as they both tend to flatten the mirror. The net torque resulting from the top half and the bottom half may then cause a spring deflection, which then causes a change in the tilt of the scan mirror.

It is to be understood that a constant angular acceleration merely produces a constant jerk force and hence a constant spring deflection. In real applications, in order to produce a time-varying deflection for the orthogonal scan, a time-varying angular acceleration may be employed by the disclosed scanning device or system. For instance, to produce a linear jerk scan, the angular acceleration can be a quadratic function.

### 5) Shaft-Based Acceleration-Responsive 2D Scanner

In some scenarios, it may be desirable to provide a 2D scanner which exhibits no substantial restoring force (e.g., no restoring force) and no preferred tilt angle for the scan mirror, but responds to angular acceleration (constant angular acceleration and/or time-varying angular acceleration) by tilting the scan mirror. In some cases, such a scanner may be referred to as “resonance-free” to indicate that the scanner does not exhibit a substantial restoring force on the tilt of the mirror that would give rise to a substantial resonance response.

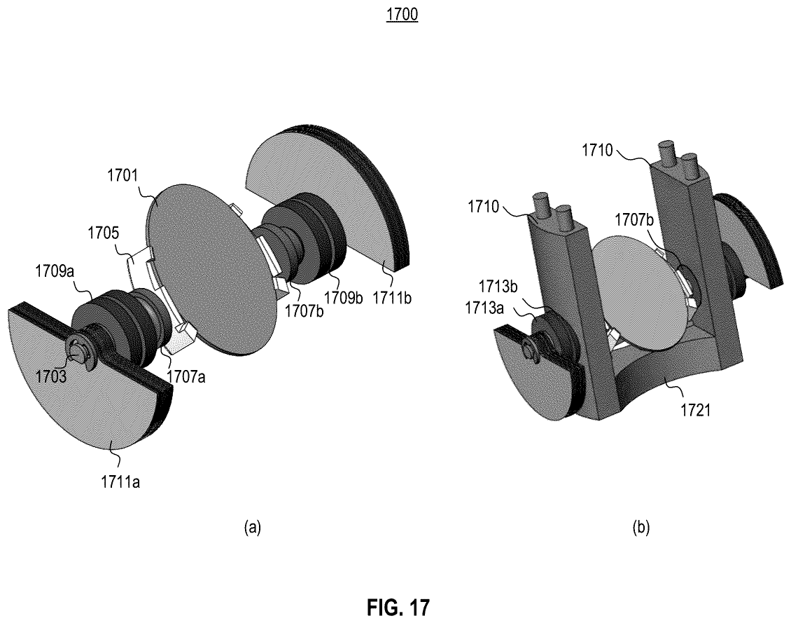

FIG. 17 illustrates an exemplary shaft-based acceleration-responsive 2D lidar scanner 1700, according to some embodiments. As illustrated in Part (a) of FIG. 17, the scanner 1700 includes a scan mirror 1701 mounted to a cradle 1705, which is mounted on a spring-free shaft aligned along a pivot axis 1703. Also aligned along the pivot axis 1703 are a pair of support bearings 1707a/1707b (together or individually referred to as support bearing 1707) adjacent to the cradle 1705, a pair of magnetic thrust bearings 1709a/1709b (together or individually referred to as magnetic thrust bearing 1709) adjacent to the support bearings 1707, and a pair of weights 1711a/1711b (together or individually referred to as weight 1711) adjacent to the magnetic thrust bearings 1709. Together, the scan mirror 1701, cradle 1705, support bearings 1707, magnetic thrust bearings 1709, and weights 1711 from the tiltable portion of the 2D scanner 1700. As can be seen in Part (b) of FIG. 17, the 2D scanner also includes a rotational base 1721.

The support bearings 1707 may locate the shaft radially and axially relative to other components, such as the housing of the lidar scanner, the mirror, and the cradle. For instance, as further illustrated in Part (b) of FIG. 17, the support bearings (e.g., support bearing 1707b) may be embedded into a support structure 1710 of the rotational base 1721 that supports the housing unit. The magnetic thrust bearings 1709 are provided in pairs on both sides outside the support structures 1710, with one piece of each pair embedded in a support structure 1710, as shown by the magnet 1713b in Part (b) of FIG. 17. The other piece 1713a of the magnet pair faces the magnet 1713b. The two magnets 1713a and 1713b have the same magnetization orientation and thus repel each other, such that the cradle 1705 and mirror 1701 remaining centered and do not slide left or right along the shaft.

A non-limiting example has been described in which magnetic thrust bearings 1709 are used to maintain the lateral position of the cradle 1705 and mirror 1701 on the shaft. In addition to or as an alternative to magnetic thrust bearings, any suitable bearings 1709 (e.g., dry-running, lubrication-free bearings) may be used to maintain the lateral position of the cradle 1705 and mirror 1701 on the shaft. For example, the bearings 1709 may include polytetrafluoroethylene (PTEF) bush bearings or PTEF bushings (e.g., Teflon bushings).

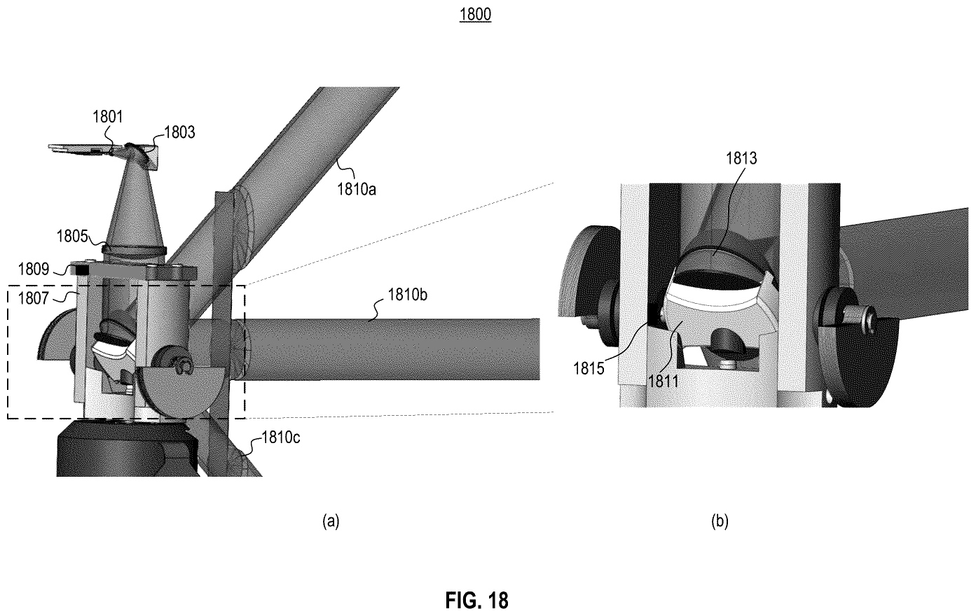

FIG. 18 illustrates an exemplary lidar system 1800 including a shaft-based acceleration-responsive 2D lidar scanner (e.g., 2D scanner 1700), according to some embodiments. As illustrated, the lidar system 1800 includes a transceiver 1801 and a mirror (“pointing mirror”) 1803 coupled to the transceiver 1801. The optical signals (e.g., laser beams) emitted by the transceiver 1801 can be reflected by the mirror 1803 towards the 2D lidar scanner. In some embodiments, the lidar system 1800 further includes an objective lens 1805 that collimates the laser beams reflected by the reflective mirror 1803. The collimated laser beams then reach the top of the housing 1807 of the lidar scanner. While the transceiver 1801, the reflective mirror 1805, and the objective lens 1805 are generally stationary, the housing 1807 of the lidar scanner including its top part is generally rotational.

In some embodiments, the top part of the housing 1807 includes a cylindrical lens 1809 that compensates for the effects of a ring lens (not shown). The ring lens may be a polycarbonate ring in a cylinder shape with a curvature that surrounds the housing 1807 of the lidar scanner. The curvature of the ring lens may introduce astigmatism into the laser beams within the lidar scanner. The cylindrical lens 1809 positioned on the top of the housing 1807 may compensate for the astigmatism introduced into the laser beams inside the lidar scanner. To allow the cylindrical lens 1809 to work properly, the cylindrical lens may be fixed to the housing 1807 and also rotate when the scan mirror spins, so as to stay with the axis of the ring lens. As also illustrated in Part (a) of FIG. 18, laser beams 1810a, 1810b, 1810c can be directed in different vertical directions by the lidar scanner based on the tilt of the scan mirror.

Part (b) of FIG. 18 provides an enlarged view of a portion of the lidar scanner 1800, according to some embodiments. As illustrated, the lidar scanner 1800 includes a cradle 1811 that holds the scan mirror 1813 in the center of the shaft 1815. The support bearings and magnetic thrust bearings keep the cradle and the mirror centered, and the weights keep the lidar scanner (specifically, the tilt angle of the scan mirror 1813) responsive to angular acceleration (e.g., constant and/or time-varying angular acceleration). The weights dynamically balance the mirror assembly, so that the scan mirror does not tilt in response to constant angular velocity but does tilt in response to constant angular acceleration and/or time-varying angular acceleration (jerk), as further described in detail below.

It is to be understood that the lidar system 1800 illustrated in FIG. 18 is merely for illustrative purposes. The disclosed 2D lidar scanner is not limited to use with the lidar system 1800 illustrated in the figure, but can be used in any suitable lidar system.

It is also to be understood that the various 2D lidar scanners are not limited to the lidar applications, but can be used in many different applications for 2D scanning. For example, the 2D lidar scanners disclosed in the disclosure can be used in many other 2D scanner devices or even 3D scanning devices. The optical signal used for scanning by the disclosed 2D lidar scanner is not limited to the laser beams, but can be applied to any other optical signal.

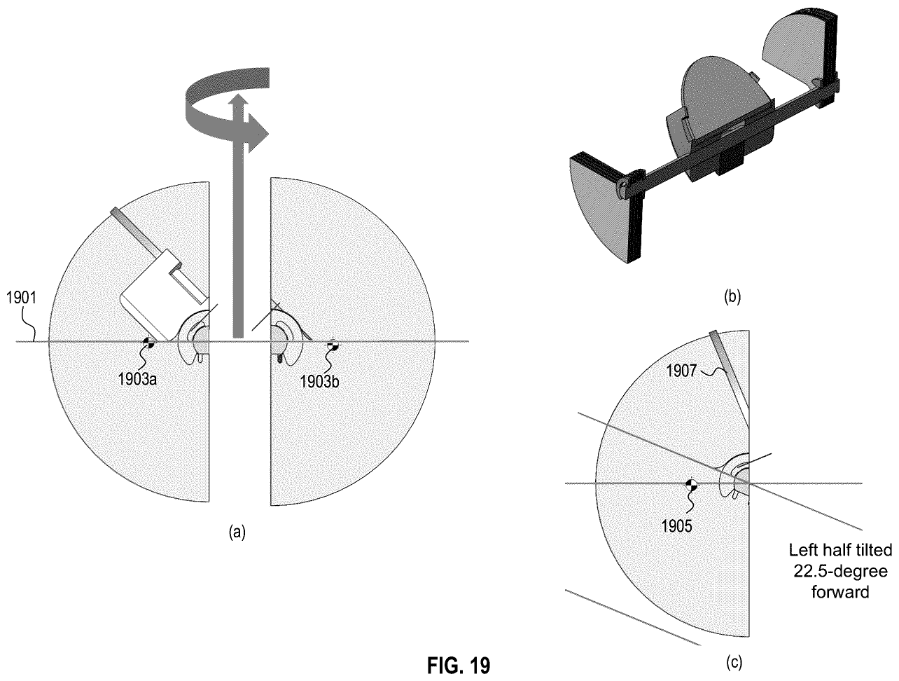

FIG. 19 illustrates a mechanism for aligning the center of mass of the tiltable portion of a scan mirror assembly of the shaft-based acceleration-responsive 2D lidar scanner 1800 in the rotation plane (spin plane) with or without a mirror tilt, according to some embodiments. Part (a) illustrates a situation where the scan mirror in the shaft-based resonance-responsive 2D lidar scanner 1800 is oriented at 45 degrees with respect to the spin axis. The left half of the mirror assembly (as defined by the dynamic balance plane) is illustrated for ease of explanation. As illustrated, when the weights are properly configured, the center of mass 1903a for the left half of the tiltable portion of the scan mirror assembly can be positioned in the rotation plane 1901. Similarly, the center of mass 1903b for the right half of the tiltable portion of the scan mirror assembly can be positioned in the rotation plane 1901.

Part (b) of FIG. 19 illustrates a scenario in which the scan mirror of the shaft-based acceleration-responsive 2D lidar scanner is tilted. As illustrated, the tiltable portion of the scan mirror assembly including the mirror and the attached weights are tilted forward at a certain angle (e.g., 22.5 degrees relative to the orientation of the scan mirror in Part(a) of FIG. 19). As illustrated further in Part (c) of FIG. 19, even though the tiltable portion of the scan mirror assembly is tilted, the center of mass 1905 of the left half of the tiltable portion still remains in the rotation plane. Similarly, the center of mass of the right half of the tiltable portion also remains in the rotation plane when the tiltable portion of the scan mirror assembly is tilted. Since the centers of mass of the left and right halves are both in the rotation plane, there is no tendency for the tiltable portion of the scan mirror assembly to tilt in response to rotation of the scan mirror assembly with no acceleration (constant velocity).

It is to be understood that, while the center of mass of the left half and the center of mass of the right half remain in the rotation plane when the tiltable portion of the scan mirror assembly of the shaft-based acceleration-responsive 2D lidar scanner is tilted, the offset of the center of mass for the left half or the right half may not remain in the same location but rather change after the mirror is tilted.

As described earlier, the movable member of the shaft-based acceleration-responsive 2D lidar scanner 1800 comprises a shaft rather than a spring. Thus, the scanner 1800 does not exhibit a restoring force that would give rise to a substantial resonance response. Accordingly, the scanner 1800 does not exhibit a substantial resonance-based response to jerk forces. Rather, the scanner 1800 translates angular acceleration forces applied to the scan mirror assembly into forces that tend to tilt the scan mirror, as further described in detail below.

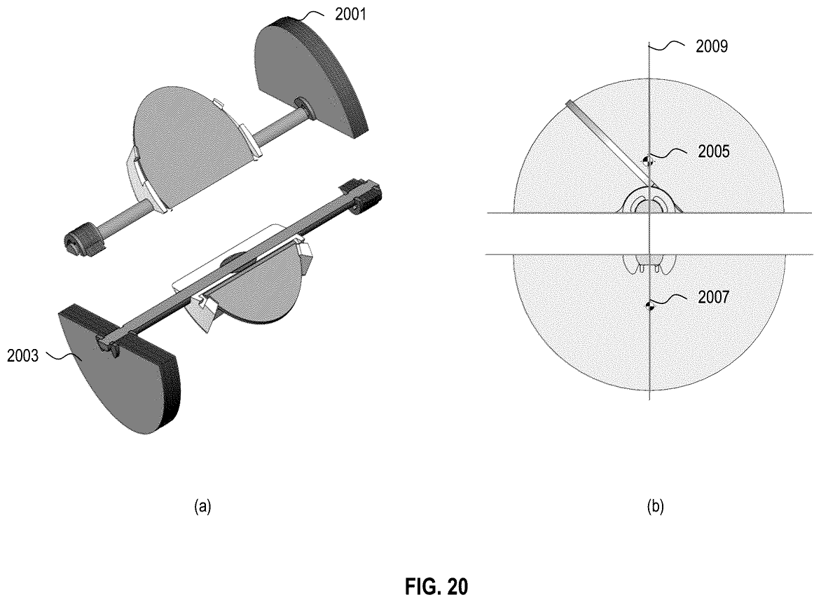

FIG. 20 illustrates a mechanism for driving the tiltable portion of the scan mirror assembly of the shaft-based acceleration-responsive 2D lidar scanner 1800 to tilt, according to some embodiments. As illustrated in Part (a) of FIG. 20, the tiltable portion of the scan mirror assembly can be divided into a top half 2001 and a bottom half 2003 separated by the rotation plane. The center of mass of the top half is located over the rotation plane, as indicated by the center of mass 2005 in Part (b) of FIG. 20. While the center of mass 2005 is illustrated as being aligned with the spin axis 2009 in Part (b) of FIG. 20, the exact position of the center of mass 2005 may vary and shift to the side (e.g., the right side of the spin axis) where most of the weight on the top half resides. Similarly, the center of mass 2007 of the bottom half may be located below the rotation plane and shifted to the side (e.g., the left side of the spin axis) where most of the weight on the bottom half resides. Since the center of mass of the top half and the center of mass of the bottom half are not located in the rotation plane, the forces associated with the angular acceleration of the scan mirror assembly generate a net torque acting on the centers of mass (2005, 2007), which is related to the angular acceleration.

The generated torque for the top half and the bottom half of the mirror assembly also relates to the angular acceleration. That is, the larger the angular acceleration, the higher the torque for each of the top/bottom halves of the mirror assembly. In addition, since the torques for the top half/bottom halves of the mirror assembly are in the opposite directions, the two forces are additive. Accordingly, a net torque will be generated when there is an angular acceleration, and the value of the generated net torque for the mirror assembly is proportional to the angular acceleration. Therefore, to control the scan mirror assembly to achieve 2D scan, an angular acceleration may be applied to the mirror assembly. The vertical field of view and the rate of the resulting scan may relate to the rate and duration of the angular acceleration. For example, higher rates of angular acceleration may yield faster scan rates and longer durations may yield larger vertical fields of view. Furthermore, periodic applications of positive and negative angular acceleration may result in periodic repetition of the vertical scan.

The tilt response of the shaft-based acceleration-responsive 2D scanner may have a proportional relationship with the mass value m of the center of mass of the top or bottom half and the square of the radius (or offset) r of the center of mass of the top or bottom half with respect to the tilt axis. Accordingly, in the design of the above-described shaft-based acceleration-responsive 2D lidar scanner, the mass of the weights for the top half and the bottom half may be adjusted (e.g., by changing the shims included in the weight) to adjust the mass value and/or the offset of the center of mass of the top and/or bottom half with respect to the tilt axis. These adjustments also can affect the scanner's vertical field of view. For example, a mirror assembly with mass values of 0.7 g for the centers of mass of the top and bottom halves may have 10× the vertical field of view (and 10× the “tilt response”) of another mirror assembly with mass values of 7 g for the centers of mass of the top and bottom halves.

In some scenarios, it may be desirable to minimize the changes in the angular velocity of the scan mirror assembly during a scanning process. In such scenarios, reducing the offsets of the centers of mass of the weights relative to the spin axis may be a preferred option.

It is also to be understood that, the direction of the torque for the top half or the bottom half of the tiltable portion of the mirror assembly can be also controlled by controlling the sign of the angular acceleration. For instance, when the scan mirror assembly experiences an angular acceleration, the generated torque may act to tilt the scan mirror up, and when the scan mirror assembly experiences an angular deceleration, the generated torque may act to tilt the scan mirror down. Accordingly, by controlling the acceleration and deceleration of the scan mirror assembly, the scan mirror can be controlled to tilt up or down, thereby achieving a continuous 2D scan of the field of view.

In some embodiments, the tilt of the scan mirror during a scanning process can be also monitored by using a magnetic sensor to detect the change in orientation of a magnet affixed to back of the scan mirror, as previously described with reference to FIG. 12B. In such a configuration, the weights of the scan mirror assembly may be adjusted to accommodate the weight of the magnet affixed to the scan mirror.

In addition, in the above described various 2D lidar scanners, a scan mirror assembly can include any machine, such as a crank, shaft, gear, and the like, where the machine can produce a displacement of a load in response to a rotation. For example, a resonance-free, acceleration-responsive 2D scanner can use a machine other than a shaft to tilt the scan mirror in response to rotational acceleration, e.g., a crank, gear, etc. The machine can be embedded in a non-inertial reference frame. The different embodiments of 2D lidar scanners disclosed herein apply force in or to the non-inertial reference frame in different ways as described in each embodiment, so as to provide two degrees of freedom (e.g., in the x- or horizontal direction and the y- or vertical direction).

In some embodiments, the above-described shaft-based acceleration-responsive 2D scanner operates with a 90 degree vertical FOV, a 5 Hz frame rate, 10 scan lines per frame, vertical scan resolution of 10 degrees, and an average angular velocity of 3,000 RPM, with the scan mirror's tilt controlled by angular velocity variation of +500 RPM.

The number of scan lines per frame provided by the acceleration-responsive 2D scanner may vary linearly with the average angular velocity of the scan mirror assembly. In some embodiments, the average angular velocity is between approximately 1,500 RPM and 18,000 RPM, yielding between 5 and 60 scan lines per frame. At 60 scan lines per frame over a 90 degree vertical FOV, the vertical scan resolution is approximately 1.5 degrees.

The angular velocity variation that produces a 90 degree field of view for the acceleration-responsive 2D scanner may be proportional to the mass of the scan mirror assembly. In some embodiments, a 90 degree field of view is achieved with angular velocity variation between approximately +125 RPM and approximately +1,000 RPM.

The vertical scan resolution of the acceleration-responsive 2D scanner may be inversely proportional to the vertical FOV. In some embodiments, the vertical FOV is between 20 degrees and 90 degrees. At 40 scan lines per frame over a 20 degree FOV, the vertical scan resolution is approximately 0.5 degrees.

Any suitable drive waveform may be used to drive the rotational component of the acceleration-responsive 2D scanner in accordance with the parameters described above. In some embodiments, the drive waveform is a linear function. For example, the drive waveform may be a triangle wave (e.g., an asymmetric triangle wave). For example, the drive waveform may be shaped such that 2D scanner performs a first unidirectional vertical scan (e.g., from the top of the vertical FOV to the bottom of the vertical FOV) in which 80% of a frame's scan lines are sensed, followed by a second unidirectional vertical scan (e.g., from the bottom of the vertical FOV to the top of the vertical FOV) in which 20% of the frame's scan lines are sensed. Any suitable distribution of scan lines (symmetric or asymmetric) between the first and second unidirectional vertical scans corresponding to a frame may be used, and such distribution may be controlled by adjusting the slopes of the triangle wave.

Additional Embodiments, Computing Devices, and Information Handling Systems

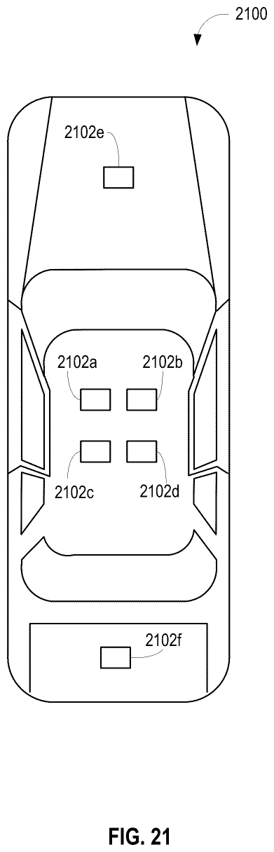

In some embodiments, lidar systems and techniques described herein may be used to provide mapping and/or autonomous navigation for a vehicle. FIG. 21 illustrates a vehicle 2100 having a plurality of sensors 2102. As shown, a first sensor 2102a, a second sensor 2102b, a third sensor 2102c, and a fourth sensor 2102d may be positioned in a first location on (or inside) the vehicle 2100 (e.g., the roof). Likewise, a fifth sensor 2102e may be positioned in a second location on (or inside) the vehicle 2100 (e.g., the front of the vehicle 2100) and a sixth sensor 2102f may be positioned in a third location on (or inside) the vehicle 2100 (e.g., the back of the vehicle 2100). In other examples, a different number or configuration of sensors may be used.

In some examples, at least one sensor of the plurality of sensors 2102 is configured to provide (or enable) 3D mapping of the vehicle's surroundings. In certain examples, at least one sensor of the plurality of sensors 2102 is used to provide autonomous navigation for the vehicle 2100 within an environment. In one example, each sensor 2102 includes at least one lidar system, device, or chip. The lidar system(s) included in each sensor 2102 may include any of the lidar systems disclosed herein. In some examples, at least one sensor of the plurality of sensors 2102 may be a different type of sensor (e.g., camera, radar, etc.). In one example, the vehicle 2100 is a car; however, in other examples, the vehicle 2100 may be a truck, boat, plane, drone, vacuum cleaner (e.g., robot vacuum cleaner), robot, train, tractor, ATV, or any other type of vehicle or moveable object.

In some embodiments, lidar systems and techniques described herein may be implemented using Silicon photonics (SiP) technologies. SiP is a material platform from which photonic integrated circuits (PICs) can be produced. SiP is compatible with CMOS (electronic) fabrication techniques, which allows PICs to be manufactured using established foundry infrastructure. In PICs, light propagates through a patterned silicon optical medium that lies on top of an insulating material layer (e.g., silicon on Insulator (SOI)). In some cases, direct bandgap materials (e.g., indium phosphide (InP)) are used to create light (e.g., laser) sources that are integrated in an SiP chip (or wafer) to drive optical or photonic components within a photonic circuit. SiP technologies are increasingly used in optical datacom, sensing, biomedical, automotive, astronomy, aerospace, AR/VR, AI applications, navigation, identification imaging, drones, robotics, etc.

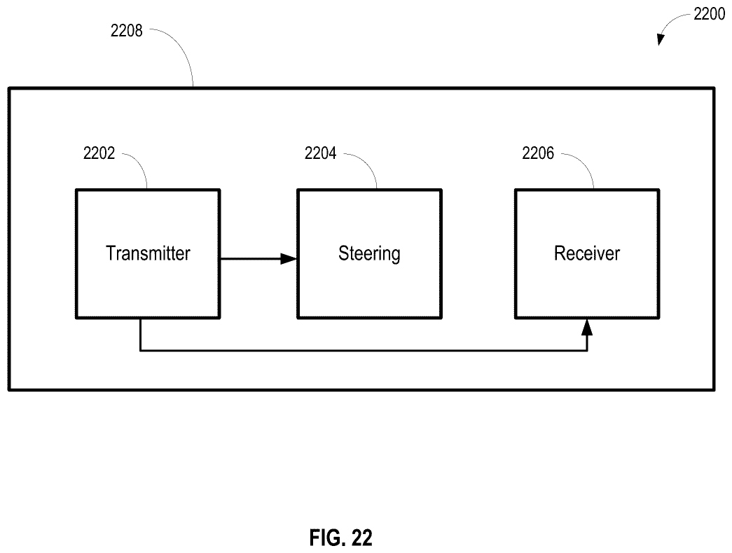

FIG. 22 is a block diagram of a silicon photonic integrated circuit (PIC) 2200 in accordance with aspects described herein. In one example, the lidar systems described herein can be implemented as the PIC 2200. The PIC 2200 includes a transmitter module 2202, a steering module 2204, and a receiver module 2206. As shown, the transmitter module 2202, the steering module 2204, and the receiver module 2206 are integrated on a silicon substrate 2208. In other examples, the transmitter module 2202, the steering module 2204, or the receiver module 2206 may be included on a separate substrate. In some embodiments, the steering module 2204 is used by the PIC 2200 in connection with transmission (e.g., emission) and reception (e.g., collection) of optical signals. In some examples, the silicon substrate 2208 includes a silicon layer (e.g., 200 nm-10 micron thickness) disposed over an oxide layer (e.g., approximately 2 micron thickness). In certain examples, the silicon substrate 2208 can include multiple silicon and/or oxide layers.

In one example, the transmitter module 2202 includes at least one laser source. In some examples, the laser source(s) are implemented using a direct bandgap material (e.g., InP) and integrated on the silicon substrate 2208 via hybrid integration. The transmitter module 2202 may also include at least one splitter, a combiner, and/or a direction selective device that are implemented on the silicon substrate 2208 via monolithic or hybrid integration. In some examples, the laser source(s) are external to the PIC 2200 and the laser signal(s) can be provided to the transmission module 2202.

In some embodiments, lidar systems and techniques described herein may be implemented using micro-electromechanical systems (MEMS). A MEMS is a miniature device that has both mechanical and electronic components. The physical dimension of a MEMS can range from several millimeters to less than one micrometer. Lidar systems may include one or more scanning mirrors implemented as a MEMS mirror (or an array of MEMS mirrors). Each MEMS mirror may be a single-axis MEMS mirror or dual-axis MEMS mirror. The MEMS mirror(s) may be electromagnetic mirrors. A control signal is provided to adjust the position of the mirror to direct light in at least one scan direction (e.g., horizontal and/or vertical). The MEMS mirror(s) can be positioned to steer light transmitted by the lidar system and/or to steer light received by the lidar system. MEMS mirrors are compact and may allow for smaller form-factor lidar systems, faster control speeds, and more precise light steering compared to other mechanical-scanning lidar methods. MEMS mirrors may be used in solid-state (e.g., stationary) lidar systems and rotating lidar systems.

In embodiments, aspects of the techniques described herein (e.g., timing the emission of the transmitted signal, processing received return signals, and so forth) may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), network storage device, or any other suitable device and may vary in size, shape, performance, functionality, and price.

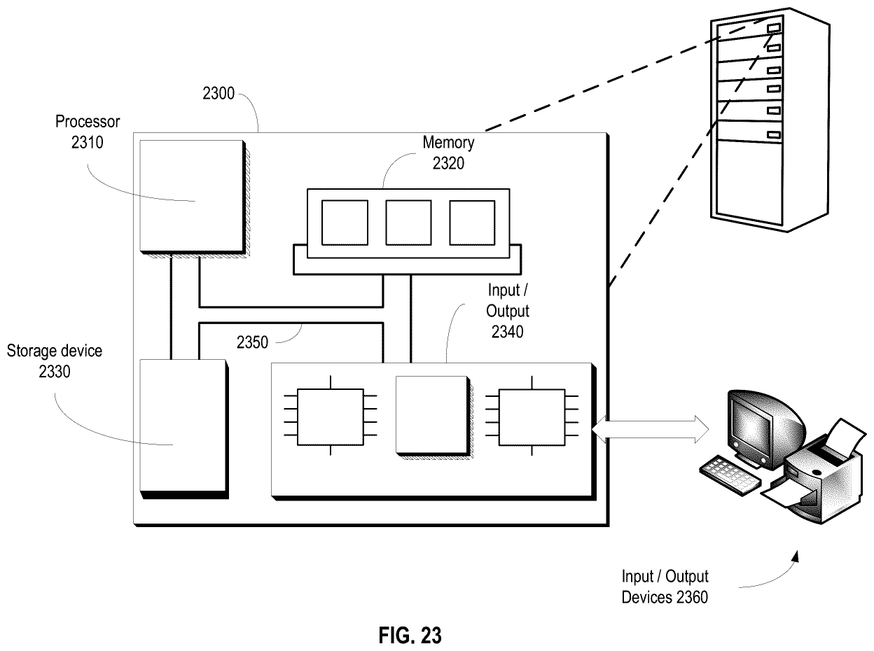

FIG. 23 is a block diagram of an example computer system 2300 that may be used in implementing the technology described in this document. General-purpose computers, network appliances, mobile devices, or other electronic systems may also include at least portions of the system 2300. The system 2300 includes a processor 2310, a memory 2320, a storage device 2330, and an input/output device 2340. Each of the components 2310, 2320, 2330, and 2340 may be interconnected, for example, using a system bus 2350. The processor 2310 is capable of processing instructions for execution within the system 2300. In some implementations, the processor 2310 is a single-threaded processor. In some implementations, the processor 2310 is a multi-threaded processor. In some implementations, the processor 2310 is a programmable (or reprogrammable) general purpose microprocessor or microcontroller. The processor 2310 is capable of processing instructions stored in the memory 2320 or on the storage device 2330.

The memory 2320 stores information within the system 2300. In some implementations, the memory 2320 is a non-transitory computer-readable medium. In some implementations, the memory 2320 is a volatile memory unit. In some implementations, the memory 2320 is a non-volatile memory unit.

The storage device 2330 is capable of providing mass storage for the system 2300. In some implementations, the storage device 2330 is a non-transitory computer-readable medium. In various different implementations, the storage device 2330 may include, for example, a hard disk device, an optical disk device, a solid-date drive, a flash drive, or some other large capacity storage device. For example, the storage device may store long-term data (e.g., database data, file system data, etc.). The input/output device 2340 provides input/output operations for the system 2300. In some implementations, the input/output device 2340 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 2360. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 2330 may be implemented in a distributed way over a network, for example as a server farm or a set of widely distributed servers, or may be implemented in a single computing device.

Although an example processing system has been described in FIG. 23, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, a data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit), or a programmable general purpose microprocessor or microcontroller. A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA, an ASIC, or a programmable general purpose microprocessor or microcontroller.

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic disks, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD- ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship with each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

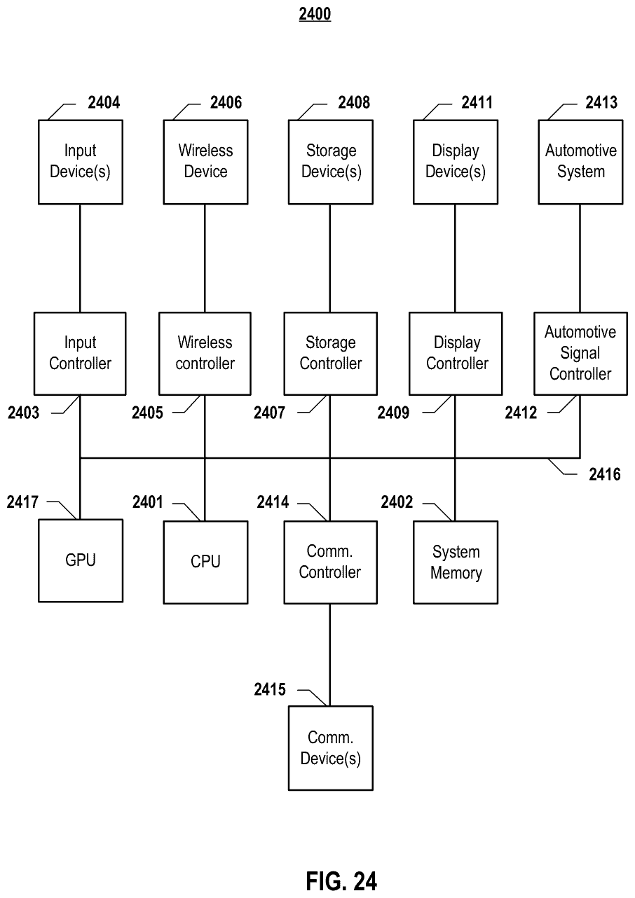

FIG. 24 depicts a simplified block diagram of a computing device/information handling system (or computing system) according to embodiments of the present disclosure. It will be understood that the functionalities shown for system 2400 may operate to support various embodiments of an information handling system—although it shall be understood that an information handling system may be differently configured and include different components.

As illustrated in FIG. 24, system 2400 includes one or more central processing units (CPU) 2401 that provide(s) computing resources and control(s) the computer. CPU 2401 may be implemented with a microprocessor or the like, and may also include one or more graphics processing units (GPU) 2417 and/or a floating point coprocessor for mathematical computations. System 2400 may also include a system memory 2402, which may be in the form of random-access memory (RAM), read-only memory (ROM), or both.

A number of controllers and peripheral devices may also be provided. For example, an input controller 2403 represents an interface to various input device(s) 2404, such as a keyboard, mouse, or stylus. There may also be a wireless controller 2405, which communicates with a wireless device 2406. System 2400 may also include a storage controller 2407 for interfacing with one or more storage devices 2408, each of which includes a storage medium such as a magnetic tape or disk, or an optical medium that might be used to record programs of instructions for operating systems, utilities, and applications, which may include embodiments of programs that implement various aspects of the techniques described herein. Storage device(s) 2408 may also be used to store processed data or data to be processed in accordance with some embodiments. System 2400 may also include a display controller 2409 for providing an interface to a display device 2411, which may be a cathode ray tube (CRT), a thin film transistor (TFT) display, or other type of display. The computing system 2400 may also include an automotive signal controller 2412 for communicating with an automotive system 2413. A communications controller 2414 may interface with one or more communication devices 2415, which enables system 2400 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN), or through any suitable electromagnetic carrier signals including infrared signals.

In the illustrated system, all major system components may connect to a bus 2416, which may represent more than one physical bus. However, various system components may or may not be in physical proximity to one another. For example, input data and/or output data may be remotely transmitted from one physical location to another. In addition, programs that implement various aspects of some embodiments may be accessed from a remote location (e.g., a server) over a network. Such data and/or programs may be conveyed through any of a variety of machine-readable medium including, but not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Some embodiments may be encoded upon one or more non-transitory, computer-readable media with instructions for one or more processors or processing units to cause steps to be performed. It shall be noted that the one or more non-transitory, computer-readable media shall include volatile and non-volatile memory. It shall also be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that some embodiments may further relate to computer products with a non-transitory, tangible computer-readable medium that has computer code thereon for performing various computer-implemented operations. The medium and computer code may be those specially designed and constructed for the purposes of the techniques described herein, or they may be of the kind known or available to those having skill in the relevant arts. Examples of tangible, computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that is executed by a computer using an interpreter. Some embodiments may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the techniques described herein. One skilled in the art will also recognize that a number of the elements described above may be physically and/or functionally separated into sub-modules or combined together.

In some embodiments, aspects of the techniques described herein may be implemented using machine learning and/or artificial intelligence technologies.

“Machine learning” generally refers to the application of certain techniques (e.g., pattern recognition and/or statistical inference techniques) by computer systems to perform specific tasks. Machine learning techniques may be used to build models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

A feature of a data sample may be a measurable property of an entity (e.g., person, thing, event, activity, etc.) represented by or associated with the data sample. A value of a feature may be a measurement of the corresponding property of an entity or an instance of information regarding an entity. Features can also have data types. For instance, a feature can have an image data type, a numerical data type, a text data type (e.g., a structured text data type or an unstructured (“free”) text data type), a categorical data type, or any other suitable data type. In general, a feature's data type is categorical if the set of values that can be assigned to the feature is finite.

As used herein, “model” may refer to any suitable model artifact generated by the process of using a machine learning algorithm to fit a model to a specific training data set. The terms “model,” “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

“Artificial intelligence” (AI) generally encompasses any technology that demonstrates intelligence. Applications (e.g., machine-executed software) that demonstrate intelligence may be referred to herein as “artificial intelligence applications,” “AI applications,” or “intelligent agents.” An intelligent agent may demonstrate intelligence, for example, by perceiving its environment, learning, and/or solving problems (e.g., taking actions or making decisions that increase the likelihood of achieving a defined goal). In many cases, intelligent agents are developed by organizations and deployed on network-connected computer systems so users within the organization can access them. Intelligent agents are used to guide decision-making and/or to control systems in a wide variety of fields and industries, e.g., security; transportation; risk assessment and management; supply chain logistics; and energy management. Intelligent agents may include or use models.

Some non-limiting examples of AI application types may include inference applications, comparison applications, and optimizer applications. Inference applications may include any intelligent agents that generate inferences (e.g., predictions, forecasts, etc.) about the values of one or more output variables based on the values of one or more input variables. In some examples, an inference application may provide a recommendation based on a generated inference. For example, an inference application for a lending organization may infer the likelihood that a loan applicant will default on repayment of a loan for a requested amount, and may recommend whether to approve a loan for the requested amount based on that inference. Comparison applications may include any intelligent agents that compare two or more possible scenarios. Each scenario may correspond to a set of potential values of one or more input variables over a period of time. For each scenario, an intelligent agent may generate one or more inferences (e.g., with respect to the values of one or more output variables) and/or recommendations. For example, a comparison application for a lending organization may display the organization's predicted revenue over a period of time if the organization approves loan applications if and only if the predicted risk of default is less than 20% (scenario #1), less than 10% (scenario #2), or less than 5% (scenario #3). Optimizer applications may include any intelligent agents that infer the optimum values of one or more variables of interest based on the values of one or more input variables. For example, an optimizer application for a lending organization may indicate the maximum loan amount that the organization would approve for a particular customer.

As used herein, “data analytics” may refer to the process of analyzing data (e.g., using machine learning models, artificial intelligence, models, or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

Data analytics tools are used to guide decision-making and/or to control systems in a wide variety of fields and industries, e.g., security; transportation; risk assessment and management; supply chain logistics; and energy management. The processes used to develop data analytics tools suitable for carrying out specific data analytics tasks generally include steps of data collection, data preparation, feature engineering, model generation, and/or model deployment.

As used herein, “spatial data” may refer to data relating to the location, shape, and/or geometry of one or more spatial objects. Data collected by lidar systems, devices, and chips described herein may be considered spatial data. A “spatial object” may be an entity or thing that occupies space and/or has a location in a physical or virtual environment. In some cases, a spatial object may be represented by an image (e.g., photograph, rendering, etc.) of the object. In some cases, a spatial object may be represented by one or more geometric elements (e.g., points, lines, curves, and/or polygons), which may have locations within an environment (e.g., coordinates within a coordinate space corresponding to the environment). In some cases, a spatial object may be represented as a cluster of points in a 3D point-cloud.

As used herein, “spatial attribute” may refer to an attribute of a spatial object that relates to the object's location, shape, or geometry. Spatial objects or observations may also have “non-spatial attributes.” For example, a residential lot is a spatial object that that can have spatial attributes (e.g., location, dimensions, etc.) and non-spatial attributes (e.g., market value, owner of record, tax assessment, etc.). As used herein, “spatial feature” may refer to a feature that is based on (e.g., represents or depends on) a spatial attribute of a spatial object or a spatial relationship between or among spatial objects. As a special case, “location feature” may refer to a spatial feature that is based on a location of a spatial object. As used herein, “spatial observation” may refer to an observation that includes a representation of a spatial object, values of one or more spatial attributes of a spatial object, and/or values of one or more spatial features.

Spatial data may be encoded in vector format, raster format, or any other suitable format. In vector format, each spatial object is represented by one or more geometric elements. In this context, each point has a location (e.g., coordinates), and points also may have one or more other attributes. Each line (or curve) comprises an ordered, connected set of points. Each polygon comprises a connected set of lines that form a closed shape. In raster format, spatial objects are represented by values (e.g., pixel values) assigned to cells (e.g., pixels) arranged in a regular pattern (e.g., a grid or matrix). In this context, each cell represents a spatial region, and the value assigned to the cell applies to the represented spatial region.

“Computer vision” generally refers to the use of computer systems to analyze and interpret image data. In some embodiments, computer vision may be used to analyze and interpret data collected by lidar systems (e.g., point-clouds). Computer vision tools generally use models that incorporate principles of geometry and/or physics. Such models may be trained to solve specific problems within the computer vision domain using machine learning techniques. For example, computer vision models may be trained to perform object recognition (recognizing instances of objects or object classes in images), identification (identifying an individual instance of an object in an image), detection (detecting specific types of objects or events in images), etc.

Computer vision tools (e.g., models, systems, etc.) may perform one or more of the following functions: image pre-processing, feature extraction, and detection/segmentation. Some examples of image pre-processing techniques include, without limitation, image re-sampling, noise reduction, contrast enhancement, and scaling (e.g., generating a scale space representation). Extracted features may be low-level (e.g., raw pixels, pixel intensities, pixel colors, gradients, patterns and textures (e.g., combinations of colors in close proximity), color histograms, motion vectors, edges, lines, corners, ridges, etc.), mid-level (e.g., shapes, surfaces, volumes, patterns, etc.), or high-level (e.g., objects, scenes, events, etc.). The detection/segmentation function may involve selection of a subset of the input image data (e.g., one or more images within a set of images, one or more regions within an image, etc.) for further processing.

### Some Embodiments

Some embodiments may include any of the following:

(A1) A two-dimensional (2D) lidar scanner, including a scan mirror assembly including a scan mirror and a mirror-tilting apparatus coupled to the scan mirror; and a rotary component coupled to the scan mirror assembly and operable to drive a rotary motion of the scan mirror assembly about a first axis, wherein the mirror-tilting apparatus is configured to tilt the scan mirror about a second axis substantially perpendicular to the first axis in response to the rotary component driving the rotary motion of the scan mirror assembly, and wherein an orientation of the scan mirror is operable to control a first angle of reflection of a laser beam in a first dimension and a second angle of reflection of the laser beam in a second dimension during a lidar scanning process.

(A2) The 2D lidar scanner of A1, wherein the scan mirror is an off-axis parabolic mirror or a flat mirror.

(A3) The 2D lidar scanner of any of A1-A2, wherein the rotary component is a brushless motor or a pulsed rotary motor.

(A4) The 2D lidar scanner of any of A1-A3, wherein the mirror-tilting apparatus includes a movable member, the scan mirror being mounted to the movable member.

(A5) The 2D lidar scanner of A4, wherein the movable member includes a set of flexures or a shaft aligned with the second axis.

(A6) The 2D lidar scanner of any of A4-A5, wherein a center of mass of a first portion of the scan mirror assembly is positioned in a rotation plane and a center of mass of a second portion of the scan mirror assembly is positioned in the rotation plane, wherein the first portion and the second portion of the scan mirror assembly are divided by a plane defined by the first axis and the second axis.

(A7) The 2D lidar scanner of any of A1-A6, further comprising a set of weights configured to position the centers of mass of the first and second portions of the scan mirror assembly.

(A8) The 2D lidar scanner of A4, wherein the movable member includes a shaft and a cradle mounted to the shaft, the scan mirror being mounted to the cradle.

(A9) The 2D lidar scanner of A8, wherein the scan mirror assembly further includes one or more supports coupled to a housing, the scan mirror and mirror-tilting apparatus being disposed within the housing.

(A10) The 2D lidar scanner of A8 or A9, wherein the scan mirror assembly further includes a cylindrical lens.

(A11) The 2D lidar scanner of any of A8-A10, wherein the mirror-tilting apparatus further includes a set of support bearings and a set of dry-running, lubrication-free bearings configured to position the one or more supports, the cradle, and the scan mirror along the shaft.

(A12) The 2D lidar scanner of any of A1-A11, further including a controller coupled to the rotary component and configured to control the rotary motion of the scan mirror assembly.

(A13) The 2D lidar scanner of A12, wherein the controller is configured to control the scan mirror assembly to rotate at a continually increasing angular velocity or a continuously decreasing angular velocity for a period of time corresponding to a scan of a portion of a field of view of the 2D lidar scanner.

(A14) The 2D lidar scanner of A12, wherein the controller is configured to control the scan mirror assembly to rotate with a time-varying angular acceleration for a period of time corresponding to a scan of a portion of a field of view of the 2D lidar scanner.

(A15) The 2D lidar scanner of any of A1-A14, further including a sensor configured to sense an orientation of the scan mirror with respect to the second axis.

(A16) The 2D lidar scanner of A15, wherein the sensor includes a magnet, a ferrous motor shaft, and a magnetic sensor, and wherein the magnet is disposed under the scan mirror, a first end of the ferrous motor shaft faces the magnet and a second end of the ferrous motor shaft faces the magnetic sensor.

(A17) The 2D lidar scanner of A16, wherein the magnet includes a single-pole magnet, a split magnet, or a multi-pole magnet having an even number of poles.

(A18) The 2D lidar scanner of A16 or A17, wherein the magnetic sensor includes a Hall sensor.

(A19) The 2D lidar scanner of any of A1-A18, wherein the rotary component is operable to drive the rotary motion of the scan mirror assembly about the first axis by applying a first driving force to the scan mirror tending to rotate the scan mirror about the first axis, and wherein the mirror-tilting apparatus is configured to tilt the scan mirror about the second axis by applying a second force to the scan mirror tending to tilt the scan mirror about the second axis in response to application of the first driving force to the scan mirror assembly.

(A20) The 2D lidar scanner of A19, wherein the mirror-tilting apparatus is configured to transform the first driving force tending to rotate the scan mirror assembly about the first axis into the second force tending to tilt the scan mirror about the second axis.

(A21) The 2D lidar scanner of any of A1-A20, wherein the first angle of reflection is defined with respect to the first axis, and wherein the second angle of reflection is defined with respect to the second axis.

(A22) The 2D lidar scanner of any of A1-A21, wherein an angle of intersection between the first axis and the second axis is between 70 and 110 degrees, between 75 and 105 degrees, between 80 and 100 degrees, between 85 and 95 degrees, between 86 and 94 degrees, between 87 and 93 degrees, between 88 and 92 degrees, between 89 and 91 degrees, between 89.5 and 90.5 degrees, between 89.8 and 90.2 degrees, between 89.9 and 90.1 degrees, or 90 degrees.

(A23) A lidar device, including an optical emitter configured to emit a laser beam; and the 2D scanner of any of claims A1-A22, wherein the scan mirror of the 2D scanner is configured to reflect the laser beam.

(A24) The lidar device of A23, further including a controller coupled to the 2D scanner and configured to control the rotary motion of the scan mirror assembly.

(A25) The lidar device of A24, wherein the controller is further configured to control the optical emitter to emit a plurality of laser pulses at a varying rate, such that a uniform spot distribution is achieved in the first dimension during a period in which an angular velocity of the scan mirror assembly varies.

(A26) A method including emitting a laser beam towards the 2D lidar scanner of any of claims A1-A25; and controlling the rotary component to drive the rotary motion of the scan mirror assembly, thereby controlling the first and second angles of reflection of the laser beam

### Terminology

The phrasing and terminology used herein is for the purpose of description and should not be regarded as limiting.

Unless otherwise noted, as used herein, the terms “rotate,” “rotational,” and the like refer to any type of rotary motion about an axis (e.g., a fixed axis), including (without limitation) rotary motion with constant angular velocity (e.g., rotary motion without acceleration), rotary motion with varying angular velocity (e.g., rotary motion with acceleration) (including motion in which the angular direction of rotation is reversed), rotary motion with varying angular acceleration (jerk), etc. Examples have been described in which the forces created by the rotary motion of a scan mirror assembly (and/or by changes in the rotary motion of a scan mirror assembly) act on a scan mirror disposed in a non-inertial reference frame (e.g., mounted on the scan mirror assembly) to tilt the scan mirror (e.g., to maintain or change the tilt angle of the scan mirror) about an axis (e.g., an axis perpendicular to the axis of the rotary motion).

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A two-dimensional (2D) lidar scanner, comprising:
a scan mirror assembly including a scan mirror and a mirror-tilting apparatus coupled to the scan mirror; and
a rotary component coupled to the scan mirror assembly and operable to drive a rotary motion of the scan mirror assembly about a first axis;
wherein the mirror-tilting apparatus is configured to tilt the scan mirror about a second axis substantially perpendicular to the first axis in response to the rotary component driving the rotary motion of the scan mirror assembly, and
wherein an orientation of the scan mirror is operable to control a first angle of reflection of a laser beam in a first dimension and a second angle of reflection of the laser beam in a second dimension during a lidar scanning process.

2. The 2D lidar scanner of claim 1, wherein the scan mirror is an off-axis parabolic mirror or a flat mirror.

3. The 2D lidar scanner of claim 1, wherein the rotary component is a brushless motor or a pulsed rotary motor.

4. The 2D lidar scanner of claim 1, wherein the mirror-tilting apparatus comprises a movable member, the scan mirror being mounted to the movable member.

5. The 2D lidar scanner of claim 4, wherein the movable member comprises a set of flexures or a shaft aligned with the second axis.

6. The 2D lidar scanner of claim 4, wherein a center of mass of a first portion of the scan mirror assembly is positioned in a rotation plane and a center of mass of a second portion of the scan mirror assembly is positioned in the rotation plane, wherein the first portion and the second portion of the scan mirror assembly are divided by a plane defined by the first axis and the second axis.

7. The 2D lidar scanner of claim 6, further comprising a set of weights configured to position the centers of mass of the first and second portions of the scan mirror assembly.

8. The 2D lidar scanner of claim 4, wherein the movable member comprises a shaft and a cradle mounted to the shaft, the scan mirror being mounted to the cradle.

9. The 2D lidar scanner of claim 8, wherein the scan mirror assembly further comprises one or more supports coupled to a housing, the scan mirror and mirror-tilting apparatus being disposed within the housing.

10. The 2D lidar scanner of claim 9, wherein the mirror-tilting apparatus further comprises a set of support bearings and a set of dry-running, lubrication-free bearings configured to position the one or more supports, the cradle, and the scan mirror along the shaft.

11. The 2D lidar scanner of claim 1, further comprising a controller coupled to the rotary component and configured to rotate at a continually increasing angular velocity or a continuously decreasing angular velocity for a period of time corresponding to a scan of a portion of a field of view of the 2D lidar scanner.

12. The 2D lidar scanner of claim 1, further comprising a controller coupled to the rotary component and configured to control the scan mirror assembly to rotate with a time-varying angular acceleration for a period of time corresponding to a scan of a portion of a field of view of the 2D lidar scanner.

13. The 2D lidar scanner of claim 1, further comprising a sensor configured to sense an orientation of the scan mirror with respect to the second axis, wherein the sensor comprises a magnet, a ferrous motor shaft, and a magnetic sensor, and wherein the magnet is disposed under the scan mirror, a first end of the ferrous motor shaft faces the magnet and a second end of the ferrous motor shaft faces the magnetic sensor.

14. The 2D lidar scanner of claim 13, wherein the magnet comprises a single-pole magnet, a split magnet, or a multi-pole magnet having an even number of poles or wherein the magnetic sensor comprises a Hall sensor.

15. The 2D lidar scanner of claim 1, wherein the rotary component is operable to drive the rotary motion of the scan mirror assembly about the first axis by applying a first driving force to the scan mirror tending to rotate the scan mirror about the first axis, and wherein the mirror-tilting apparatus is configured to tilt the scan mirror about the second axis by applying a second force to the scan mirror tending to tilt the scan mirror about the second axis in response to application of the first driving force to the scan mirror assembly.

16. The 2D lidar scanner of claim 15, wherein the mirror-tilting apparatus is configured to transform the first driving force tending to rotate the scan mirror assembly about the first axis into the second force tending to tilt the scan mirror about the second axis.

17. The 2D lidar scanner of claim 1, wherein the first angle of reflection is defined with respect to the first axis, and wherein the second angle of reflection is defined with respect to the second axis.

18. The 2D lidar scanner of claim 1, wherein an angle of intersection between the first axis and the second axis is between 70 and 110 degrees, between 75 and 105 degrees, between 80 and 100 degrees, between 85 and 95 degrees, between 86 and 94 degrees, between 87 and 93 degrees, between 88 and 92 degrees, between 89 and 91 degrees, between 89.5 and 90.5 degrees, between 89.8 and 90.2 degrees, between 89.9 and 90.1 degrees, or 90 degrees.

19. A lidar device comprising:
an optical emitter configured to emit a laser beam; and
a two-dimensional (2D) scanner comprising:
a scan mirror assembly including a scan mirror configured to reflect the laser beam and a mirror-tilting apparatus coupled to the scan mirror; and
a rotary component coupled to the scan mirror assembly and operable to drive a rotary motion of the scan mirror assembly about a first axis,
wherein the mirror-tilting apparatus is configured to tilt the scan mirror about a second axis substantially perpendicular to the first axis in response to the rotary component driving the rotary motion of the scan mirror assembly, and
wherein an orientation of the scan mirror is operable to control a first angle of reflection of a laser beam in a first dimension and a second angle of reflection of the laser beam in a second dimension during a lidar scanning process.

20. A method comprising:
emitting a laser beam towards a two-dimensional (2D) lidar scanner, wherein the 2D lidar scanner comprises:
a scan mirror assembly including a scan mirror and a mirror-tilting apparatus coupled to the scan mirror; and
a rotary component coupled to the scan mirror assembly and operable to drive a rotary motion of the scan mirror assembly about a first axis,
wherein the mirror-tilting apparatus is configured to tilt the scan mirror about a second axis substantially perpendicular to the first axis in response to the rotary component driving the rotary motion of the scan mirror assembly, and
wherein an orientation of the scan mirror is operable to control a first angle of reflection of a laser beam in a first dimension and a second angle of reflection of the laser beam in a second dimension during a lidar scanning process; and
controlling the rotary component to drive the rotary motion of the scan mirror assembly, thereby controlling the first and second angles of reflection of the laser beam.
